(19) United States
(12) Patent Application Publication
(10) Pub. No.: US 2026/0303839 A1
(43) Pub. Date: Oct. 1, 2026

(54) INTRA PREDICTION AUTO-REGRESSIVE COMPLEXITY REDUCTION

(71) Applicant: InterDigital CE Patent Holdings, SAS, Paris (FR)

(72) Inventors: Franck Galpin, Thorigne-Fouillard (FR); Fabrice Le Léannec, Betton (FR); Philippe Bordes, Laille (FR); Thierry Dumas, Rennes (FR)

(73) Assignee: InterDigital CE Patent Holdings, SAS, Paris (FR)

(21) Appl. No.: 19/479,319

(22) PCT Filed: Apr. 26, 2024
(86) PCT No.: PCT/EP2024/061680

§ 371 Date: Oct. 27, 2025

(30) Foreign Application Priority Data
Apr. 28, 2023 (EP) 23315128.1
Jun. 28, 2023 (EP) 23306036.7

(51) Int. Cl. H04N 19/176; H04N 19/105; H04N 19/159; H04N 19/436

(52) U.S. Cl. CPC H04N 19/176; H04N 19/105; H04N 19/159; H04N 19/436

(57) ABSTRACT

System, methods, and instrumentalities are disclosed for reducing intra prediction auto-regressive (AR) complexity. A device may obtain an auto-regressive prediction model for a current block. The device may obtain a set of reference samples. The device may determine, in parallel, a first prediction sample and a second prediction sample of the current block based on the set of reference samples and the auto-regressive prediction model. The device may decode the current block based on the first prediction sample and the second prediction sample.

### CROSS-REFERENCE TO RELATED APPLICATIONS

This application claims the benefit of European Provisional Patent Application No. EP23315128.1, filed Apr. 28, 2023, and European Provisional Patent Application No. EP23306036.7, filed Jun. 28, 2023, the contents of which are hereby incorporated by reference herein.

### BACKGROUND

Video coding systems may be used to compress digital video signals, e.g., to reduce the storage and/or transmission bandwidth needed for such signals. Video coding systems may include, for example, block-based, wavelet-based, and/or object-based systems.

### SUMMARY

System, methods, and instrumentalities are disclosed for reducing intra prediction auto-regressive (AR) complexity.

An example device (e.g., a video decoder) may obtain an auto-regressive prediction model for a current block. The device may obtain a set of reference samples. The device may determine, in parallel, a first prediction sample and a second prediction sample of the current block based on the set of reference samples and the auto-regressive prediction model. The device may decode the current block based on the first prediction sample and the second prediction sample.

An example device (e.g., a video encoder) may obtain an auto-regressive prediction model for a current block. The device may obtain a set of reference samples. The device may determine, in parallel, a first prediction sample and a second prediction sample of the current block based on the set of reference samples and the auto-regressive prediction model. The device may encode the current block based on the first prediction sample and the second prediction sample.

The set of reference samples may include a plurality of predicted samples in the current block. The first prediction sample and the second prediction sample may be located on successive lines of the current block.

The set of reference samples may include a plurality of reconstructed samples that neighbor the current block.

The device may obtain the auto-regressive prediction model for the current block by determining a parameter of the auto-regressive prediction model, based on a first subset of the set of reference samples and a second subset of the set of reference samples. The device may determine, in parallel, the first prediction sample and the second prediction sample of the current block based on the set of reference samples and the auto-regressive prediction model by generating the first prediction sample and the second prediction sample, as outputs of the auto-regressive prediction model, based on the parameter and the second subset of the set of reference samples being used as an input to the auto-regressive prediction model.

The set of reference samples may include a first column of pixels and a second column of pixels. The device may determine, in parallel, the first prediction sample and the second prediction sample of the current block based on the set of reference samples and the auto-regressive prediction model by generating a third column of pixels, as a first output of the auto-regressive prediction model, based on the first column of pixels and the second column of pixels being used as a first set of inputs to the auto-regressive prediction model. The third column of pixels may include the first prediction sample and the second prediction sample.

The device may generate a fourth column of pixels, as a second output of the auto-regressive prediction model, based on the second column of pixels and the third column of pixels being used as a second set of inputs to the auto-regressive prediction model. The fourth column of pixels may include a third prediction sample and a fourth prediction sample.

The set of reference samples comprises a first row of pixels and a second row of pixels. The device may determine, in parallel, the first prediction sample and the second prediction sample of the current block based on the set of reference samples and the auto-regressive prediction model by generating a third row of pixels, as a first output of the auto-regressive prediction model, based on the first row of pixels and the second row of pixels being used as a first set of inputs to the auto-regressive prediction model. The third row of pixels may include the first prediction sample and the second prediction sample.

The device may generate a fourth row of pixels, as a second output of the auto-regressive prediction model, based on the second row of pixels and the third row of pixels being used as a second set of inputs to the auto-regressive prediction model. The fourth row of pixels may include a third prediction sample and a fourth prediction sample.

A device may obtain a set of reconstructed samples. The device may derive an intra prediction filter based on the set of reconstructed samples. The device may apply the intra prediction filter to a subset of the set of reconstructed samples to determine a predicted sample in a current block.

The subset of the set of reconstructed samples may be a first subset of the set of reconstructed samples. The predicted sample may be a first predicted sample. The device may derive a second intra prediction filter based on a second subset of the set of reconstructed samples and the first predicted sample. The device may determine a second prediction sample in the current block based on the second intra prediction filter.

Determining the second prediction sample in the current block based on the second intra prediction filter may involve applying the second intra prediction filter to a third subset of the set of reconstructed samples and the first predicted sample to determine the second predicted sample.

The set of reconstructed samples may be a first set of reconstructed samples. The predicted sample may be a first predicted sample. The device may apply the intra prediction filter to a second set of reconstructed samples to determine a second predicted sample.

Systems, methods, and instrumentalities described herein may involve a decoder. In some examples, the systems, methods, and instrumentalities described herein may involve an encoder. In some examples, the systems, methods, and instrumentalities described herein may involve a signal (e.g., from an encoder and/or received by a decoder). A computer-readable medium may include instructions for causing one or more processors to perform methods described herein. A computer program product may include instructions which, when the program is executed by one or more processors, may cause the one or more processors to carry out the methods described herein.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example video encoder.

FIG. 3 illustrates an example video decoder.

FIG. 4 illustrates an example of a system in which various aspects and examples may be implemented.

FIG. 5 illustrates example locations of samples used for the derivation of linear model parameters.

FIG. 6 illustrates an example effect of a slope adjustment on a cross-component linear model (CCLM).

FIG. 7 illustrates an example spatial part of a convolutional filter.

FIG. 8 illustrates an example reference area used to derive filter coefficients.

FIG. 9 illustrates an example spatial part of a gradient and location based convolutional cross-component model (GL-CCCM) convolutional filter.

FIG. 10 illustrates an example spatial part of non-down-sampled CCCM luma samples (e.g., terms).

FIG. 11 illustrates an example down-sampling filter.

FIG. 12 illustrates example types of reconstructed areas.

FIG. 13 illustrates example types of filter shapes.

FIG. 14 illustrates examples of prediction for different positions in a current block.

FIG. 15 illustrates an example 4×4 model.

FIG. 16 illustrates an example of split the current block to be predicted into sub-blocks to break dependencies between the auto-regressive prediction on each sub-block.

FIG. 17 illustrates an example of boundary filtering.

FIGS. 18A and 18B illustrate an example of column-wise AR prediction.

FIGS. 19A and 19B illustrate an example of column-wise AR prediction, with the prediction of each block portion being independent.

FIGS. 20A and 20B illustrate an example of column-wise AR prediction with extended input.

FIGS. 21A and 21B illustrate an example of row-wise AR prediction.

FIGS. 22A and 22B illustrate an example of row-wise AR prediction, with the prediction of each block portion being independent.

FIG. 23 illustrates an example 3×3 model.

FIG. 24 illustrates an example 3×4 model.

FIG. 25 illustrates an example of a learned 3×3 model.

FIG. 26 illustrates an example of down-sampling reconstruction.

FIGS. 27A and 27B illustrate examples of position-dependent intra prediction extrapolation (EIP)-based prediction of a sample in a current block.

FIGS. 28A-28C illustrate an example of column-wise AR prediction, row-wise AR prediction, and the resulting two predictions being blended.

FIG. 29 illustrates an example method for prediction of the current block by blending a column-wise AR prediction and a row-wise AR prediction, using parallelism.

### DETAILED DESCRIPTION

A more detailed understanding may be had from the following description, given by way of example in conjunction with the accompanying drawings.

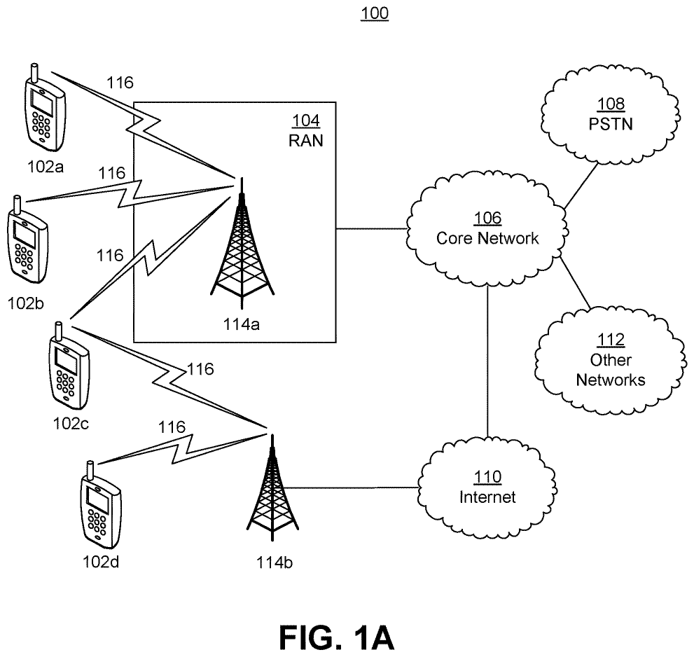

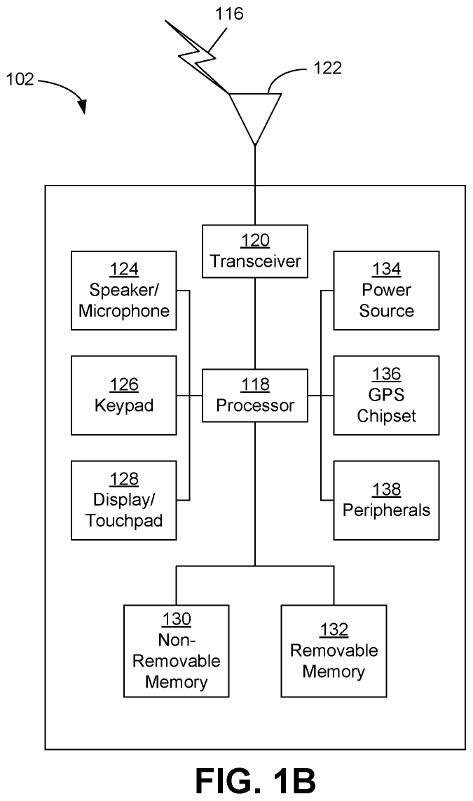

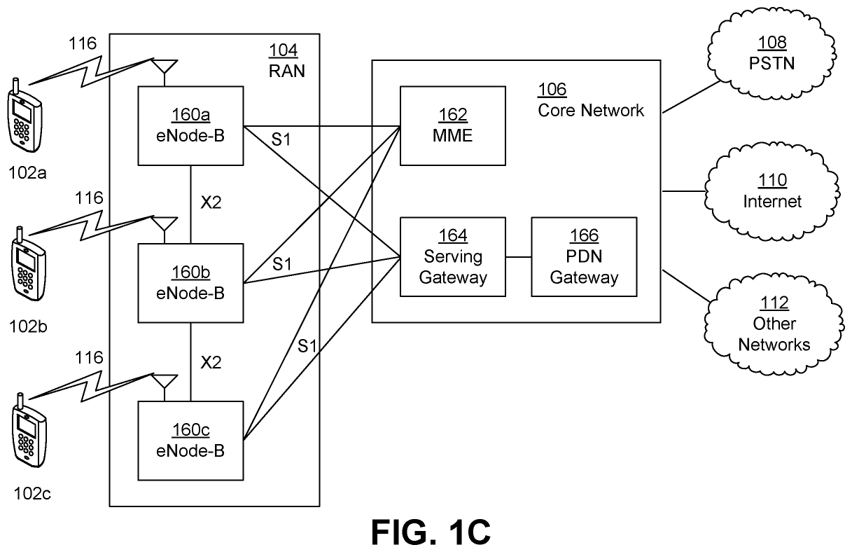

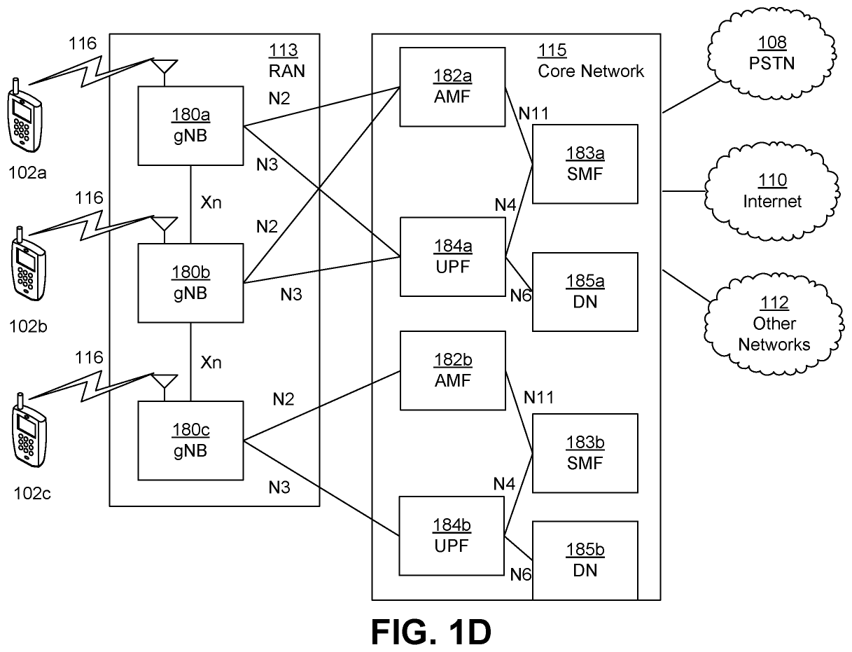

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA,” may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.1 lah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, examples, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

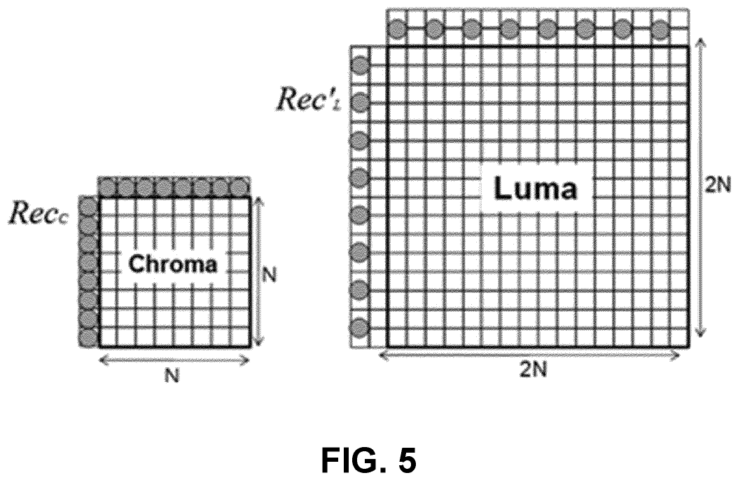

The aspects described and contemplated in this application may be implemented in many different forms. FIGS. 5-29 described herein may provide some examples, but other examples are contemplated. The discussion of FIGS. 5-29 does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first,” “second,” etc., may be used in various examples to modify an element, component, step, operation, etc., such as, for example, a “first decoding” and a “second decoding.” Use of such terms does not imply an ordering to the modified operations unless specifically required. So, in this example, the first decoding need not be performed before the second decoding, and may occur, for example, before, during, or in an overlapping time period with the second decoding.

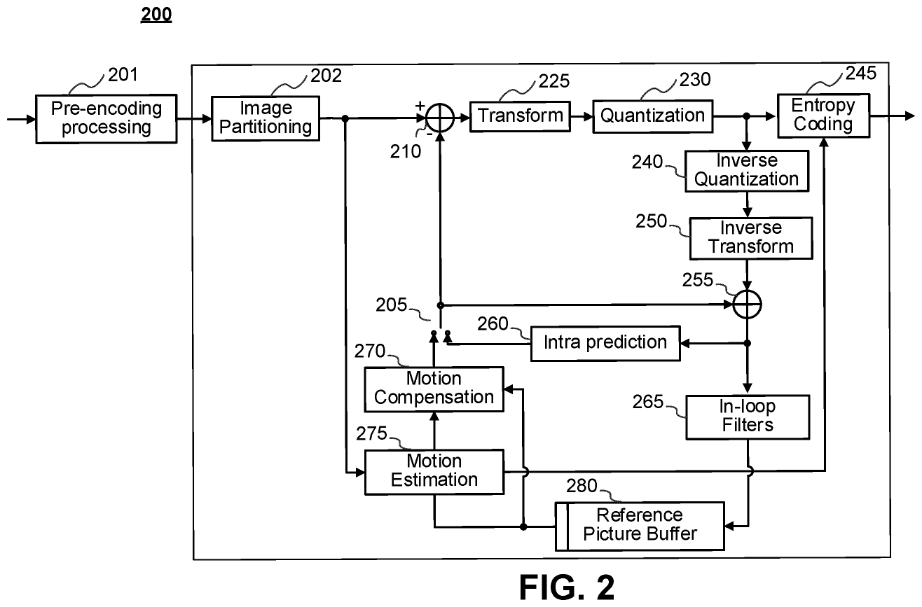

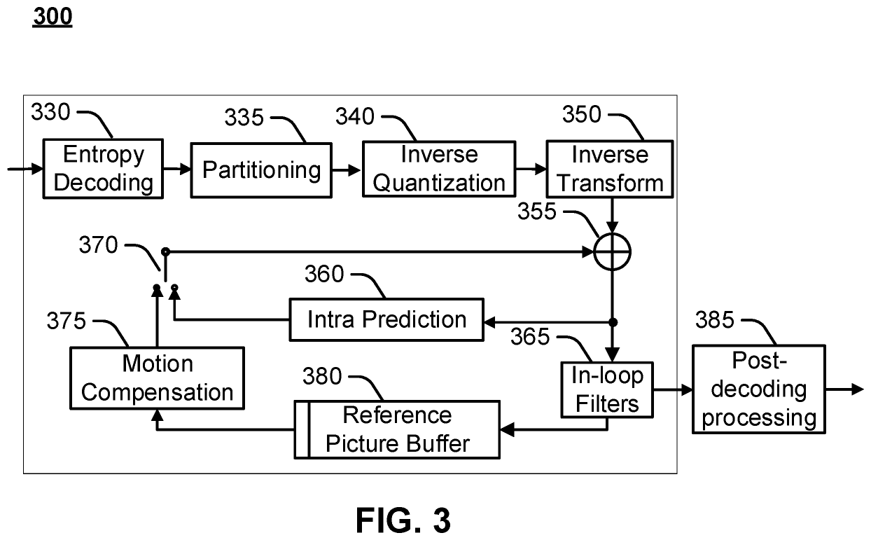

Various methods and other aspects described in this application may be used to modify modules, for example, decoding modules, of a video encoder 200 and decoder 300 as shown in FIG. 2 and FIG. 3. Moreover, the subject matter disclosed herein may be applied, for example, to any type, format or version of video coding, whether described in a standard or a recommendation, whether pre-existing or future-developed, and extensions of any such standards and recommendations. Unless indicated otherwise, or technically precluded, the aspects described in this application may be used individually or in combination.

Various numeric values are used in examples described the present application, such as 1, 2, 4, 7, 8, 16, 32, 64, etc. These and other specific values are for purposes of describing examples and the aspects described are not limited to these specific values.

FIG. 2 is a diagram showing an example video encoder 200. Variations of example encoder 200 are contemplated, but the encoder 200 is described below for purposes of clarity without describing all expected variations.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata (e.g., which may include film grain parameters determined by pre-processing as described herein) may be associated with the pre-processing and attached to the bitstream.

In the encoder 200, a picture is encoded by the encoder elements as described below. The picture to be encoded is partitioned (202) and processed in units of, for example, coding units (CUs). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

FIG. 3 is a diagram showing an example of a video decoder. In example decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which may be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block may be obtained (370) from intra prediction (360) or motion-compensated prediction (i.e., inter prediction) (375). In-loop filters (365) are applied to the reconstructed image. The filtered image is stored at a reference picture buffer (380).

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream. In an example, the decoded images (e.g., after application of the in-loop filters (365) and/or after post-decoding processing (385), if post-decoding processing is used) may be sent to a display device for rendering to a user.

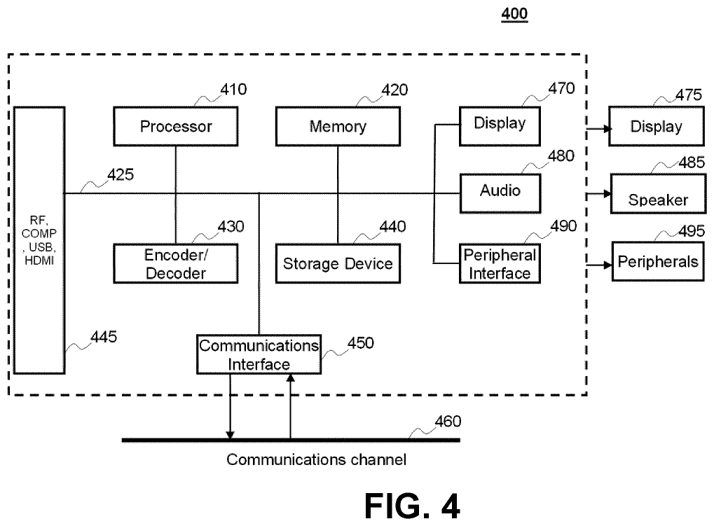

FIG. 4 is a diagram showing an example of a system in which various aspects and examples described herein may be implemented. System 400 may be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IC), multiple ICs, and/or discrete components. For example, in at least one example, the processing and encoder/decoder elements of system 400 are distributed across multiple ICs and/or discrete components. In various examples, the system 400 is communicatively coupled to one or more other systems, or other electronic devices, via, for example, a communications bus or through dedicated input and/or output ports. In various examples, the system 400 is configured to implement one or more of the aspects described in this document.

The system 400 includes at least one processor 410 configured to execute instructions loaded therein for implementing, for example, the various aspects described in this document. Processor 410 can include embedded memory, input output interface, and various other circuitries as known in the art. The system 400 includes at least one memory 420 (e.g., a volatile memory device, and/or a non-volatile memory device). System 400 includes a storage device 440, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 can include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 can include its own processor and memory. The encoder/decoder module 430 represents module(s) that may be included in a device to perform the encoding and/or decoding functions. As is known, a device can include one or both of the encoding and decoding modules. Additionally, encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in this document may be stored in storage device 440 and subsequently loaded onto memory 420 for execution by processor 410. In accordance with various examples, one or more of processor 410, memory 420, storage device 440, and encoder/decoder module 430 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some examples, memory inside of the processor 410 and/or the encoder/decoder module 430 is used to store instructions and to provide working memory for processing that is needed during encoding or decoding. In other examples, however, a memory external to the processing device (for example, the processing device may be either the processor 410 or the encoder/decoder module 430) is used for one or more of these functions. The external memory may be the memory 420 and/or the storage device 440, for example, a dynamic volatile memory and/or a non-volatile flash memory. In several examples, an external non-volatile flash memory is used to store the operating system of, for example, a television. In at least one example, a fast external dynamic volatile memory such as a RAM is used as working memory for video encoding and decoding operations.

The input to the elements of system 400 may be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, include composite video.

In various examples, the input devices of block 445 have associated respective input processing elements as known in the art. For example, the RF portion may be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which may be referred to as a channel in certain examples, (iv) demodulating the down-converted and band-limited signal, (v) performing error correction, and/or (vi) demultiplexing to select the desired stream of data packets. The RF portion of various examples includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box example, the RF portion and its associated input processing element receives an RF signal transmitted over a wired (for example, cable) medium, and performs frequency selection by filtering, down-converting, and filtering again to a desired frequency band. Various examples rearrange the order of the above-described (and other) elements, remove some of these elements, and/or add other elements performing similar or different functions. Adding elements can include inserting elements in between existing elements, such as, for example, inserting amplifiers and an analog-to-digital converter. In various examples, the RF portion includes an antenna.

The USB and/or HDMI terminals can include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the data stream as necessary for presentation on an output device.

Various elements of system 400 may be provided within an integrated housing, Within the integrated housing, the various elements may be interconnected and transmit data therebetween using suitable connection arrangement 425, for example, an internal bus as known in the art, including the Inter-IC (I2C) bus, wiring, and printed circuit boards.

The system 400 includes communication interface 450 that enables communication with other devices via communication channel 460. The communication interface 450 can include, but is not limited to, a transceiver configured to transmit and to receive data over communication channel 460. The communication interface 450 can include, but is not limited to, a modem or network card and the communication channel 460 may be implemented, for example, within a wired and/or a wireless medium.

Data is streamed, or otherwise provided, to the system 400, in various examples, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these examples is typically connected to an access point or router that provides access to external networks including the Internet for allowing streaming applications and other over-the-top communications. Other examples provide streamed data to the system 400 using a set-top box that delivers the data over the HDMI connection of the input block 445. Still other examples provide streamed data to the system 400 using the RF connection of the input block 445. As indicated above, various examples provide data in a non-streaming manner. Additionally, various examples use wireless networks other than Wi-Fi, for example a cellular network or a Bluetooth® network.

The system 400 can provide an output signal to various output devices, including a display 475, speakers 485, and other peripheral devices 495. The display 475 of various examples includes one or more of, for example, a touchscreen display, an organic light-emitting diode (OLED) display, a curved display, and/or a foldable display. The display 475 may be for a television, a tablet, a laptop, a cell phone (mobile phone), or another device. The display 475 can also be integrated with other components (for example, as in a smart phone), or separate (for example, an external monitor for a laptop). The other peripheral devices 495 include, in various examples, one or more of a stand-alone digital video disc (or digital versatile disc) (DVD, for both terms), a disk player, a stereo system, and/or a lighting system. Various examples use one or more peripheral devices 495 that provide a function based on the output of the system 400. For example, a disk player performs the function of playing the output of the system 400.

In various examples, control signals are communicated between the system 400 and the display 475, speakers 485, or other peripheral devices 495 using signaling such as AV.Link, Consumer Electronics Control (CEC), or other communications protocols that enable device-to-device control with or without user intervention. The output devices may be communicatively coupled to system 400 via dedicated connections through respective interfaces 470, 480, and 490. Alternatively, the output devices may be connected to system 400 using the communications channel 460 via the communications interface 450. The display 475 and speakers 485 may be integrated in a single unit with the other components of system 400 in an electronic device such as, for example, a television. In various examples, the display interface 470 includes a display driver, such as, for example, a timing controller (T Con) chip.

The display 475 and speakers 485 can alternatively be separate from one or more of the other components, for example, if the RF portion of input 445 is part of a separate set-top box. In various examples in which the display 475 and speakers 485 are external components, the output signal may be provided via dedicated output connections, including, for example, HDMI ports, USB ports, or COMP outputs.

The examples may be carried out by computer software implemented by the processor 410 or by hardware, or by a combination of hardware and software. As a non-limiting example, the examples may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and removable memory, as non-limiting examples. The processor 410 may be of any type appropriate to the technical environment, and can encompass one or more of microprocessors, general purpose computers, special purpose computers, and processors based on a multi-core architecture, as non-limiting examples.

Various implementations involve decoding. “Decoding,” as used in this application, can encompass all or part of the processes performed, for example, on a received encoded sequence in order to produce a final output suitable for display. In various examples, such processes include one or more of the processes typically performed by a decoder, for example, entropy decoding, inverse quantization, inverse transformation, and differential decoding. In various examples, such processes also, or alternatively, include processes performed by a decoder of various implementations described in this application, for example, a device may obtain a set of reconstructed samples. The device may derive an intra prediction filter based on the set of reconstructed samples. The device may apply the intra prediction filter to a subset of the set of reconstructed samples to determine a predicted sample in a current block. The device may decode the current block based on the predicted sample.

As further examples, in one example “decoding” refers only to entropy decoding, in another example “decoding” refers only to differential decoding, and in another example “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding,” “encoding” as used in this application can encompass all or part of the processes performed, for example, on an input video sequence in order to produce an encoded bitstream. In various examples, such processes include one or more of the processes typically performed by an encoder, for example, partitioning, differential encoding, transformation, quantization, and entropy encoding. In various examples, such processes also, or alternatively, include processes performed by an encoder of various implementations described in this application, for example, a device may obtain a set of reconstructed samples. The device may derive an intra prediction filter based on the set of reconstructed samples. The device may apply the intra prediction filter to a subset of the set of reconstructed samples to determine a predicted sample in a current block. The device may encode the current block based on the predicted sample.

As further examples, in one example “encoding” refers only to entropy encoding, in another example “encoding” refers only to differential encoding, and in another example “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that syntax elements as used herein, for example, coding syntax on intensity interval, grain parameters, block offset, scaling factor, etc., are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein may be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus may be implemented in, for example, appropriate hardware, software, and firmware. The methods may be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one example” or “an example” or “one implementation” or “an implementation,” as well as other variations thereof, means that a particular feature, structure, characteristic, and so forth described in connection with the example is included in at least one example. Thus, the appearances of the phrase “in one example” or “in an example” or “in one implementation” or “in an implementation,” as well any other variations, appearing in various places throughout this application are not necessarily all referring to the same example.

Additionally, this application may refer to “determining” various pieces of information. Determining the information can include one or more of, for example, estimating the information, calculating the information, predicting the information, or retrieving the information from memory. Obtaining may include receiving, retrieving, constructing, generating, and/or determining.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing,” intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/,” “and/or,” and “at least one of,” for example, in the cases of “A/B,” “A and/or B,” and “at least one of A and B” is intended to encompass the selection of the first listed option (A) only, or the selection of the second listed option (B) only, or the selection of both options (A and B). As a further example, in the cases of “A, B, and/or C” and “at least one of A, B, and C,” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. Encoder signals may include, for example, number of intensity intervals, number of model values, grain parameters, grain identification, scaling factor, etc. In this way, in an example the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling may be used without transmitting (implicit signaling) to simply allow the decoder to know and select the particular parameter. By avoiding transmission of any actual functions, a bit savings is realized in various examples. It is to be appreciated that signaling may be accomplished in a variety of ways. For example, one or more syntax elements, flags, and so forth are used to signal information to a corresponding decoder in various examples. While the preceding relates to the verb form of the word “signal,” the word “signal” can also be used herein as a noun.

As will be evident to one of ordinary skill in the art, implementations may produce a variety of signals formatted to carry information that may be, for example, stored or transmitted. The information can include, for example, instructions for performing a method, or data produced by one of the described implementations. For example, a signal may be formatted to carry the bitstream of a described example. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on, or accessed or received from, a processor-readable medium.

Many examples are described herein. Features of examples may be provided alone or in any combination, across various claim categories and types. Further, examples may include one or more of the features, devices, or aspects described herein, alone or in any combination, across various claim categories and types. For example, features described herein may be implemented in a bitstream or signal that includes information generated as described herein. The information may allow a decoder to decode a bitstream, the encoder, bitstream, and/or decoder according to any of the embodiments described. For example, features described herein may be implemented by creating and/or transmitting and/or receiving and/or decoding a bitstream or signal. For example, features described herein may be implemented a method, process, apparatus, medium storing instructions, medium storing data, or signal. For example, features described herein may be implemented by a TV, set-top box, cell phone, tablet, or other electronic device that performs decoding. The TV, set-top box, cell phone, tablet, or other electronic device may display (e.g., using a monitor, screen, or other type of display) a resulting image (e.g., an image from residual reconstruction of the video bitstream). The TV, set-top box, cell phone, tablet, or other electronic device may receive a signal including an encoded image and perform decoding.

Feature(s) associated with a cross-component linear model (CCLM) for intra prediction are provided herein.

Chroma samples may be predicted based on reconstructed luma samples (e.g., reconstructed luma samples of the same CU). The chroma samples may be predicted based on the reconstructed luma samples by using a linear model as follows:

$${pred}_{c} ( i , j ) = α {rec}_{L} ( i , j ) + β$$

where pred_{C}(i,j) represents the predicted chroma samples in a CU, and rec_{L}(i, j) represents the down-sampled reconstructed luma samples of the CU (e.g., the same CU).

The CCLM parameters (α and β) may be derived from neighboring chroma samples (e.g., top row(s) and left column(s)) and corresponding down-sampled luma samples (e.g., LM mode). One or more (e.g., at most four) neighboring chroma samples may be used. The neighboring chroma samples may be selected from the top row(s) (e.g., top only (LM-A)), or the left column(s) (e.g., left only (LM-L)). The selected mode (e.g., LM-A or LM-L) may be signaled.

The selected neighboring luma samples at the selected positions may be down-sampled. The selected neighboring luma samples at the selected positions may be compared to find one or more values (e.g., two smaller values: x⁰_{A} and x¹_{A}, and two larger values: x⁰_{B} and x¹_{B}). The corresponding chroma sample values may be denoted as y⁰_{A}, y¹_{A}, y⁰_{B}, and y¹_{B}. In examples, x^{A}, x_{B}, y_{A} and y_{B} may be derived as:

$$Xa ( x 0 A + x 1 A + 1 ) >> 1$$

$$Xb ( x 0 B + x 1 B + 1 ) >> 1$$

$$Ya ( y 0 A + y 1 A + 1 ) >> 1$$

$$Yb ( y 0 B + y 1 B + 1 ) >> 1$$

The linear model parameters α and β may be obtained according to the following equations:

$$α = \frac{{Y}_{a} - {Y}_{b}}{{X}_{a} - {X}_{b}}$$

$$β = {Y}_{b} - α \cdot {X}_{b}$$

FIG. 5 illustrates an example of the location of the left and above samples and the sample of the current block involved in the CCLM mode. FIG. 5 illustrates locations of the samples that may be used to derive α and β.

One or more (e.g., three) multi-model LM (MMLM) modes may be added. In an MMLM mode (e.g., each MMLM mode), the reconstructed neighboring samples may be classified into classes (e.g., two classes). For example, in an MMLM mode (e.g., each MMLM mode), the reconstructed neighboring samples may be classified into classes using a threshold. For example, the threshold may be the average of the luma reconstructed neighboring samples. The linear model of a class (e.g., of each class) may be derived using the Least-Mean-Square (LMS) method. For the CCLM mode, the LMS method may be used to derive the linear model.

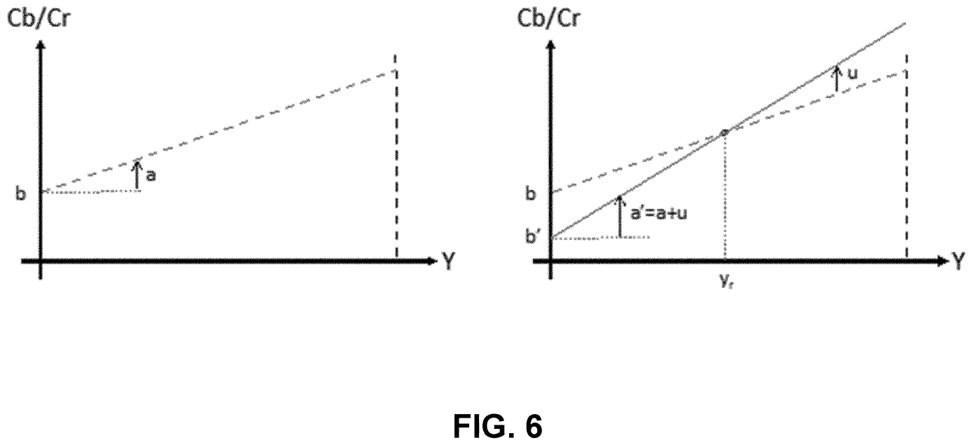

A slope adjustment may be applied to a CCLM. A slope adjustment may be applied to MMLM prediction. The adjustment may involve tilting the linear function (e.g., which maps luma values to chroma values) with respect to a center point. The center point may be determined by the average luma value of the reference samples, as depicted in FIG. 6. FIG. 6 illustrates the effect of a slope adjustment parameter “u.” The left side of FIG. 6 illustrates a model created with CCLM (e.g., regular, or non-tilted CCLM). The right side of FIG. 6 illustrates the model updated with the slope adjustment.

Feature(s) associated with convolutional cross-component model (CCCM) for intra prediction are provided herein.

A CCCM may predict chroma samples from reconstructed luma samples (e.g., in a similar way as done by CCLM). The reconstructed luma samples may be down-sampled to match the lower resolution chroma grid (e.g., if chroma sub-sampling is used).

A single model or multi-model variant of CCCM may be used. Multi-model CCCM mode may be selected for PUs that have at least 128 reference samples available. Multi-model CCCM mode may use two models. For example, multi-model CCCM mode may use a model (e.g., one model) applied to samples with values higher than the average luma reference value and another model for the rest of the samples (e.g., similar to CCLM).

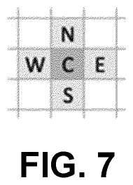

CCCM may use a convolutional filter. The convolutional filter may be made of seven parameters that weight seven inputs samples {sᵢ}, where i=0, . . . 6. One or more (e.g., five) coefficients may be applied to luminance pixel values corresponding to a plus sign shape (e.g., one coefficient to a square term (P) and the last coefficient to a bias term (B)). FIG. 7 illustrates an example spatial part (e.g., 5-tap component) of a convolutional filter. The input to the spatial 5-tap component of the filter may include of a center (C) luma sample (e.g., that is collocated with the chroma sample to be predicted) and the center luma sample's above/north (N), below/south (S), left/west (W) and right/east (E) neighbors as illustrated in FIG. 7.

A term P may be represented as power of two of the center luma sample C and scaled to the sample value range of the content:

$$P = ( C * C + midVal ) >> bitDepth$$

where midVal is a rounding term. For example, for 10-bit content P may be calculated as:

$$P = ( X * X + 512 ) >> 10$$

The bias term B may represent a scalar offset between the input and output (e.g., similarly to the offset term in CCLM). The bias term B may be set to a middle chroma value (e.g., 512 for 10-bit content).

An output of the filter may be calculated as a convolution between the filter coefficients cᵢ and the input values (e.g., clipped to the range of valid chroma samples):

$$predChromaVal = {c}_{0} C + {c}_{1} N + {c}_{2} S + {c}_{3} E + {c}_{4} W + {c}_{5} P + {c}_{6} B$$

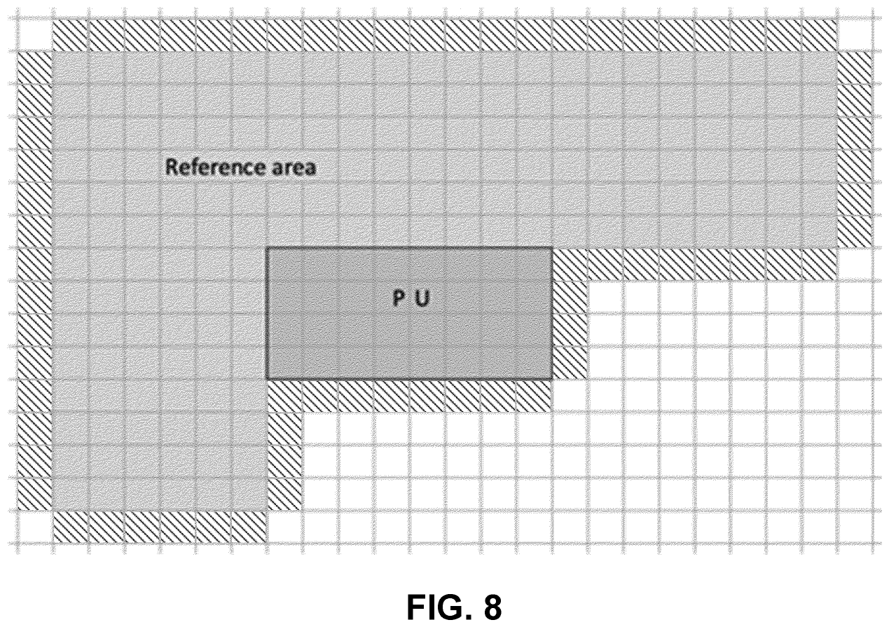

The filter coefficients cᵢ may be calculated by minimizing the mean squared error (MSE) between a set of chroma samples (e.g., reconstructed chroma samples in a reference area) and the prediction of these chroma samples via CCCM. FIG. 8 illustrates an example reference area that includes six rows and columns of chroma samples above and left of the PU, respectively. The reference area may extend one PU width to the right and one PU height below the PU boundaries. The reference area may be adjusted to include available samples (e.g., only available samples). Extensions to the reference area (e.g., illustrated with striped squares) may support the “side samples” of the plus-shaped spatial filter. The extensions to the reference area may be padded if the extensions are in unavailable areas.

FIG. 8 illustrates a reference area (e.g., with padding) used to derive the filter coefficients.

The MSE minimization may be performed by calculating an autocorrelation matrix for the luma input and a cross-correlation vector between the luma input and chroma output.

$$denote$$

$$s = ( \begin{matrix}C \\ N \\ S \\ E \\ W \\ P \\ B\end{matrix} )$$

$$where$$

$${s}_{i} = \{ \begin{matrix}i = 0 : C \\ i = 1 : N \\ i = 2 : S \\ i = 3 : E \\ i = 4 : W \\ i = 5 : P \\ i = 6 : B\end{matrix}$$

To derive the coefficients {cᵢ}, the autocorrelation matrix may be inverted. For example, the autocorrelation matrix may be LDLT decomposed. The filter coefficients (e.g., the final filter coefficients) may be calculated using back-substitution. This may be similar to the calculation of adaptive loop filter (ALF) coefficients. LDLT decomposition (e.g., sometimes referred to as alternative Cholesky decomposition) may be used (e.g., instead of Cholesky decomposition) to avoid using square root operations. A Gaussian elimination technique may be used to invert the matrix. The calculation may use integer 64-bits arithmetic.

Feature(s) associated with a gradient- and location-based convolutional cross-component model (GL-CCCM) are provided herein.

GL-CCCM is a variant of CCCM in which the convolution applies on gradient and location information (e.g., instead of the four spatial neighbor samples in the CCCM filter). The GL-CCCM filter for the prediction may be expressed as:

$$predChromaVal = c 0 C + c 1 Gy + c 2 Gx + c 3 Y + c 4 X + C 5 P + c 6 B$$

where Gy and Gx are the luma vertical and horizontal gradients, respectively, and the Y and X parameters are the vertical and horizontal coordinates, respectively, of the center luma sample location. Gy and Gx may be calculated as:

$$Gy = ( 2 N + NW + NE ) - ( 2 S + SW + SE )$$

$$Gy = ( 2 W + NW + SW ) - ( 2 E + NE + SE )$$

The rest of the parameters may be the same as (or similar to) those used in CCCM, as described herein. The reference area for the parameter calculation may be the same as (or similar to) used in CCCM.

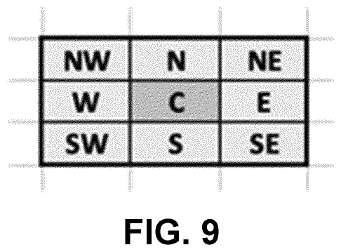

FIG. 9 illustrates an example spatial part of the GL-CCCM convolutional filter.

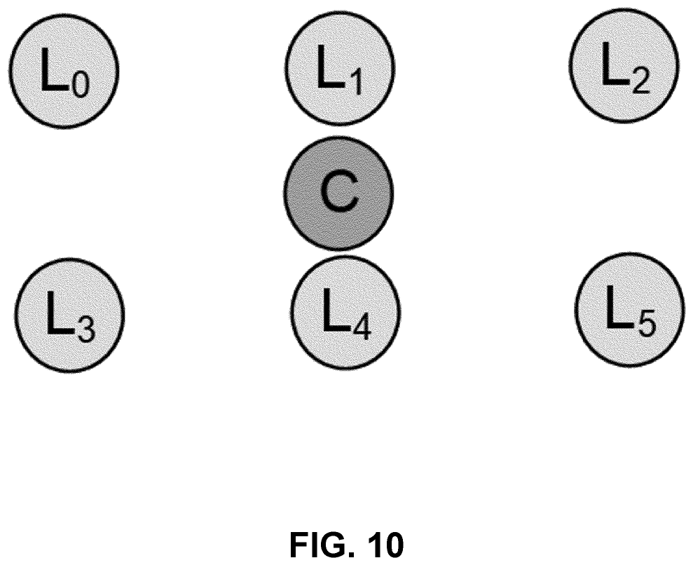

The reconstructed luma samples may not be down-sampled to match the lower resolution chroma grid. FIG. 10 illustrates an example spatial part of non-down sampled CCCM luma terms used for the convolutional filter. The co-located reconstructed luma samples (e.g., six luma samples) may be used (e.g., directly), as illustrated in FIG. 10. One or more (e.g., four) terms may be used. For example, the terms may be built from L0, L1, L2, L4, and the bias B. In this case, the number of parameters may be 10.

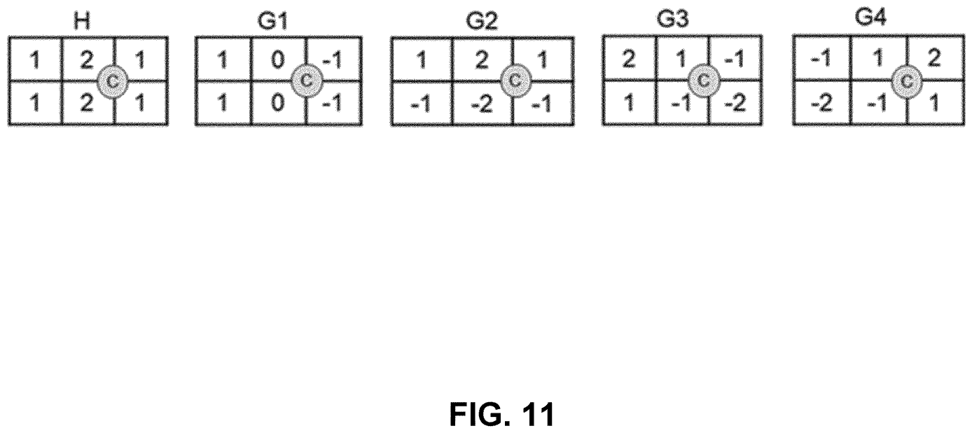

One or more (e.g., four) down-sampling filters may be used to derive the input samples to be weighted with the coefficients. The down-sampling filter model may be signaled (e.g., per CU). The prediction of the chroma samples may be derived as follows:

$$Model 1 : predChroma = c 0 * H ( C ) + c 1 * G 1 ( C ) + c 2 * G 2 ( C ) + c 3 * G 3 ( C ) + c 4 * G 4 ( C ) + c 5 * P + c 6 * B$$

$$Model 2 : predChroma = c 0 * H ( C ) + c 1 * H ( W ) + c 2 * H ( E ) + c 3 * G 1 ( C ) + c 4 * G 1 ( W ) + c 5 * G 1 ( E ) + c 6 * B$$

$$Model 3 : predChroma = c 0 * H ( C ) + c 1 * H ( N ) + c 2 * H ( S ) + c 3 * G 2 ( C ) + c 4 * G 2 ( N ) + c 5 * G 2 ( S ) + c 6 * B$$

$$Model 4 : predChroma = c 0 * H ( C ) + c 1 * H ( NE ) + c 2 * H ( SW ) + c 3 * G 4 ( C ) + c 4 * G 4 ( NE ) + c 5 * G 4 ( SW ) + c 6 * B$$

where H(⋅), G1(⋅), G2(⋅), G3(⋅), G4(⋅) are down-sampling filters applied on luma samples, as illustrated in FIG. 11.

FIG. 11 illustrates example down-sampling filters.

Feature(s) associated with intra prediction extrapolation (EIP) are provided herein.

Extrapolation filter-based intra prediction may be processed in one or more (e.g., two) steps. For example, the extrapolation filter coefficients may be obtained from neighboring reconstructed pixels of the current block (e.g., with a pre-determined template). The extrapolation may generate a predicted value (e.g., position-by-position from top-left to bottom-right within the current block).

Mean, minimum, and/or maximum value(s) may be searched. Similar to CCCM mode, a mean value may be removed if the inputs are being fed to the EIP filter (e.g., an auto-regressive prediction model). The value of the DC mode for the current block may be used as a mean value for EIP prediction. The minimum and/or maximum value(s) may be determined based on (e.g., searched from) the reconstructed pixels in the reconstructed area (e.g., with thirteen columns and thirteen rows).

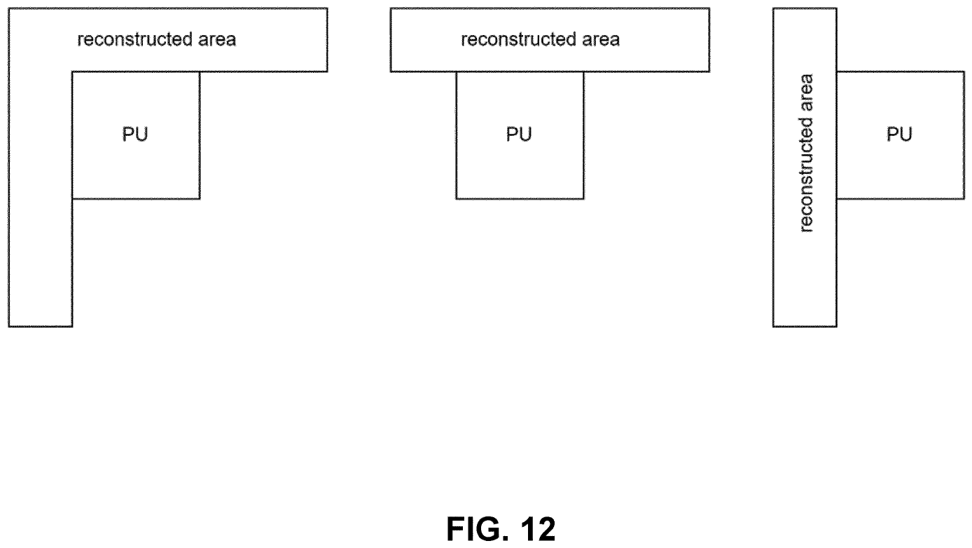

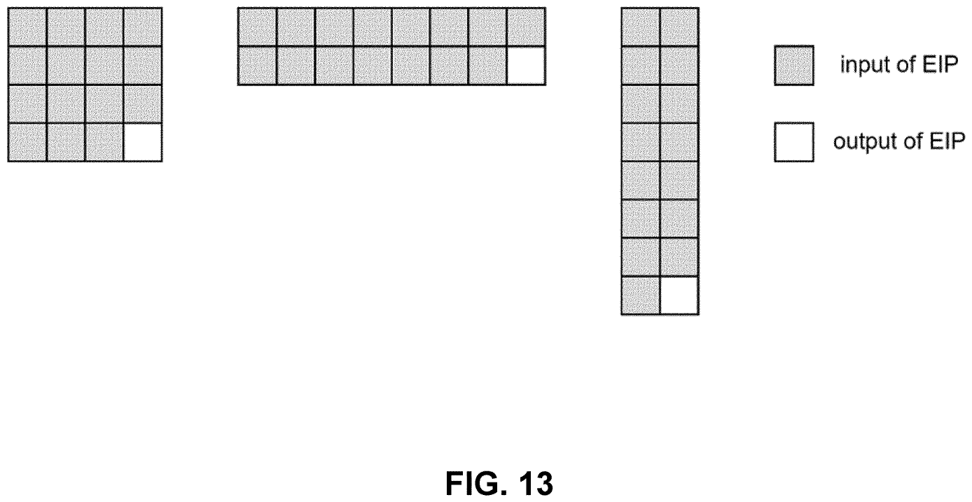

Filter coefficients may be calculated. One or more (e.g., three) types of reconstructed areas and one or more (e.g., three) filter shapes are described herein. For example, FIG. 12 illustrates three types of reconstructed areas. FIG. 13 illustrates three types of filter shapes (e.g., that have fifteen inputs and generate one output). If the current block uses the EIP mode described herein for prediction, the decoder may decode the relevant syntax elements to determine the selected type of reconstructed area and filter shape for the current block.

The selected filter may slide in the selected reconstructed area with a one-pixel step to collect input samples (e.g., one or more subsets of reference samples) and output samples of EIP. The auto-correlation matrix and cross-correlation vector may be constructed (e.g., while removing the mean value from input samples and output samples). The EIP coefficients may be obtained (e.g., in a same or similar way as in CCCM).

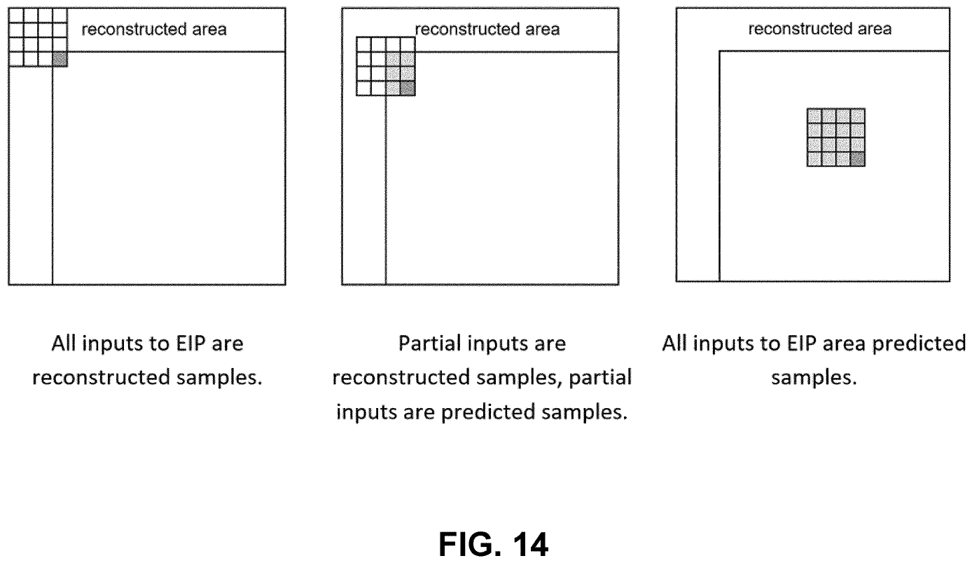

The current block may be predicted. The EIP mode may make predictions for the current block position-by-position. FIG. 14 illustrates examples of prediction for different positions in the current block. For the position located at top-left of the current block, the inputs to the EIP filter may be a set of reference samples (e.g., reconstructed samples). For the positions located along the boundaries of the current block, partial inputs to the EIP filter may be a set of reference samples, and partial inputs to the EIP filter may be previously-predicted samples. For other positions in the current block, the inputs to the EIP filter may be previously-predicted samples.

The searched minimum and maximum values may be applied to restrict the output range of each predicted value, for example:

$${pred}_{( x , y )} = clip ( min , max , ( {\sum }_{i = 0}^{n} ( {c}_{i} \times ( {t}_{( x - xoffset , y - yoffset )} - mean ) ) ) + mean )$$

where pred_{(x,y)} may indicate the predicted value at (x, y) in the current block, min, max may indicate the searched minimum and maximum values, respectively, from the thirteen reconstructed columns and rows, cᵢ may indicate the i^{th} coefficient of the derived EIP filter, t_{(x-xoffset,y-yoffset}) may indicate the reconstructed or predicted value used for the current position's prediction, and mean may indicate a value calculated by the DC prediction mode.

The EIP filter to create the intra prediction may use an auto-regressive (AR) model. The AR model may introduce large latency in the reconstruction (e.g., each sample is causally dependent on the previous one).

Feature(s) associated with wavefront processing with dependency breaking are provided herein. The latency of the prediction may be reduced by cutting the dependency to offer more parallelism opportunity. Feature(s) associated with a learned AR model with missing samples are provided herein. The AR model may be precomputed to break dependencies. AR may be performed on a subsampled block, and up-sampling on template may be learned. A model may be learned using only the template samples (e.g., as in position-dependent prediction combination (PDPC)). More directions may be used to improve the performance.

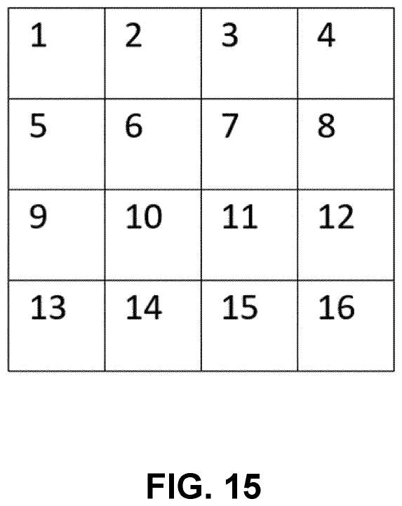

Feature(s) associated with wavefront processing with dependency breaking are provided herein. To decrease the number of cycles performed when performing wavefront processing on the block, successive lines may be allowed to be computed (e.g., may be computed together). For example, FIG. 15 illustrates samples that may be computed during wavefront processing. For example, for a 4×4 block, considering an EIP filter with a rectangular shape where the current sample uses filtered samples from top/left only (e.g., not from above-right or bottom-left) the wavefront processing may be the following: Cycle 1: sample 1 is computed; Cycle 2: samples 2 and 5 are computed in parallel; Cycle 3: samples 3, 6, and 9 are computed in parallel; Cycle 4: samples 4, 7, 10, and 13 are computed in parallel; Cycle 5: samples 8, 11, and 14 are computed in parallel; Cycle 6: samples 12 and 15 are computed in parallel; Cycle 7: sample 16 is computed.

To break the dependency and use less cycles, the processing of successive lines may be allowed. If a sample is missing, the missing sample may be replaced by the top or left value. In this case, the cycles may be the following: Cycle 1: samples 1 and 5 are computed in parallel (e.g., where sample 5 replaces sample 1 by the sample on the right of sample 1 or the top of sample 1); Cycle 2: samples 2, 6, 9, and 13 are computed in parallel (e.g., the same principle applies); Cycle 3: samples 3, 7, 10, and 14 are computed in parallel; Cycle 4: samples 4, 8, 11, and 15 are computed in parallel; Cycle 5: samples 12 and 16 are computed in parallel. In some examples, more lines may be allowed to be processed in parallel.

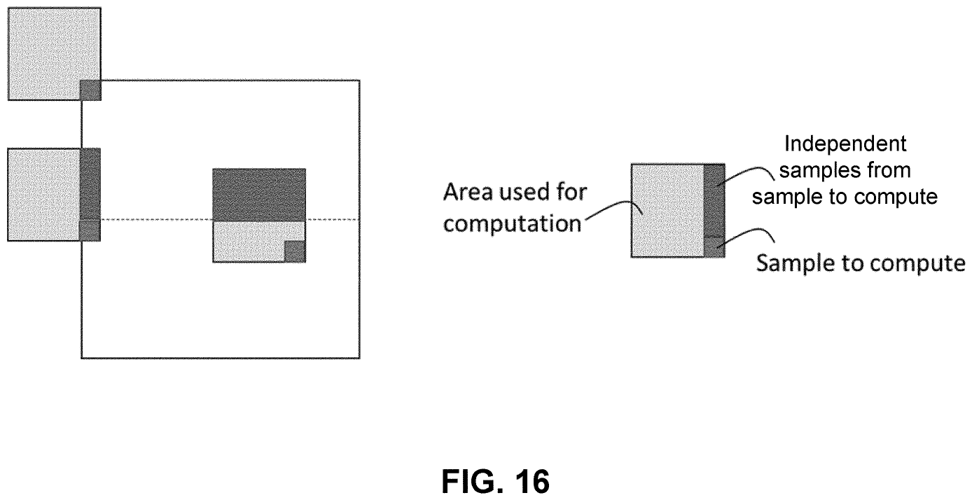

Dependency may be reduced. The dependencies may be broken by splitting the process into N independent processes, as illustrated in FIG. 16. FIG. 16 illustrates an example of splitting the current block into sub-blocks to break dependencies between the auto-regressive prediction on each sub-block.

The value of N may depend on the block size (e.g., to keep the maximum number of reconstructed samples with dependency below a threshold). The block may be split vertically. The block may be split horizontally. The block may be split both horizontally and vertically.

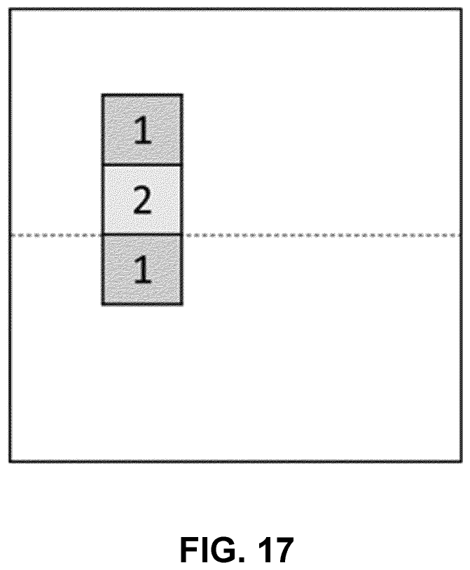

The boundary between the independent areas may be filtered (e.g., after processing) to avoid large variation in the computed samples values. FIG. 17 illustrates an example of boundary filtering. For samples near the side (e.g., each side) of the boundary, a simple low pass filter may be applied. The low pass filter may be, for example, a [1 2 1] filter, as illustrated in FIG. 17.

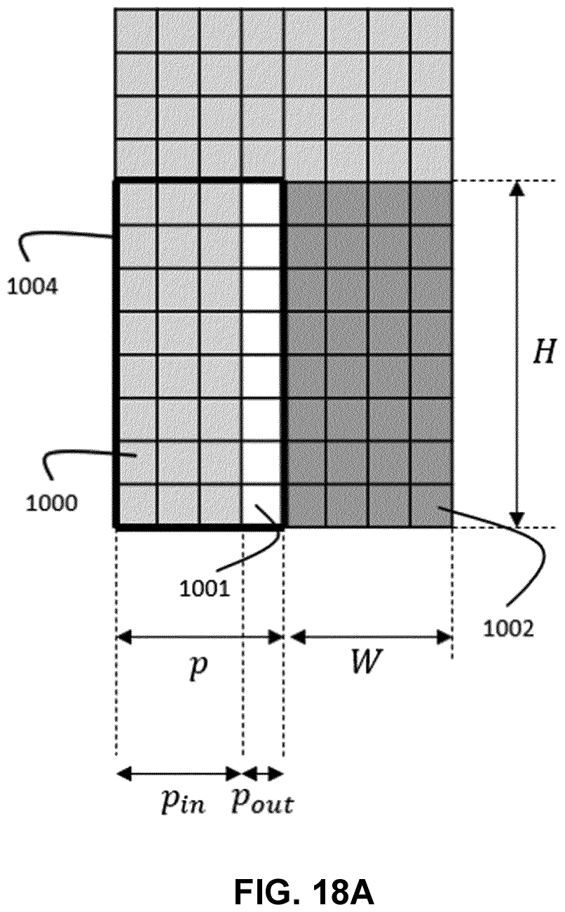

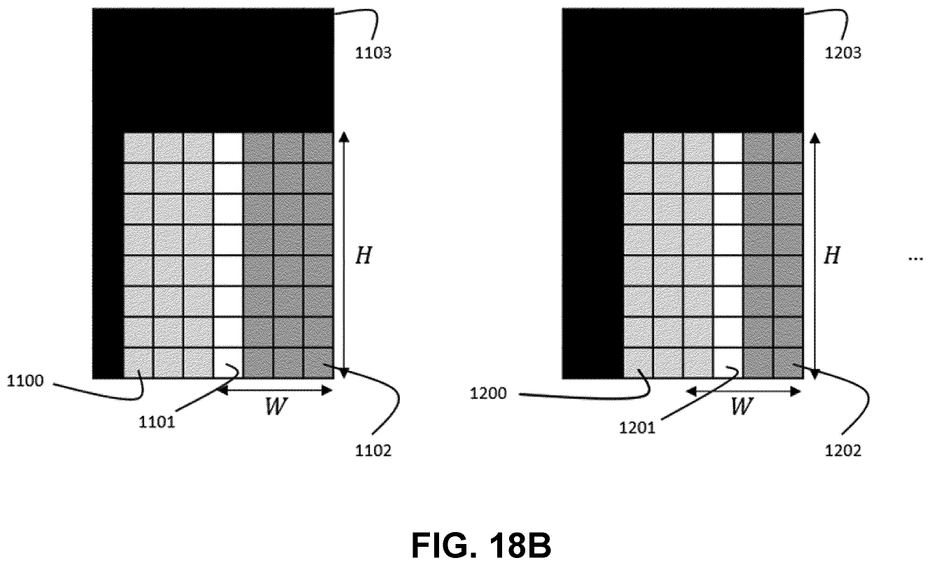

Feature(s) associated with column-wise AR are provided herein. The AR may predict the current block by sequentially predicting sets of columns of this block. FIGS. 18A and 18B illustrate an example of column-wise AR predicting the current W×H block, where W=4, H=8, p=4, and pₒᵤₜ=1. FIG. 18A illustrates an example of learning of the AR model using a neighborhood of decoded pixels around the current W×H block. FIG. 18B illustrates the prediction of this W×H block using the learned AR model (e.g., from one set of columns of the current block to the next one).

In FIG. 18A, different examples for learning the AR model may be collected from the neighborhood of decoded pixels of the current W×H block. An example 1004, framed in black, may include the set 1000 of decoded pixels at the input of the AR model and one or more subsets of the set of reference samples (e.g., the set 1001 of ground truth pixels). Different examples may be extracted by translating the black frame within a predefined neighborhood of the decoded pixels around the current block. The parameters of the AR model may be learned from the set of collected examples (e.g., based on techniques described herein).

As illustrated on the left side of FIG. 18B, the predicted samples 1101 may be generated by applying the AR model to the input set 1100 of decoded pixels. The decoded pixels 1103 may not be involved in the AR process (e.g., at the current step). The remaining samples 1102 may be predicted.

As illustrated on the right side of FIG. 18B, the predicted samples 1201 may be computed by applying the AR model to the input 1200. The input 1200 may include decoded pixels and pixels that were predicted (e.g., at the previous step). The decoded pixels 1203 may not be involved in the AR process (e.g., at the current step). The remaining samples 1202 may be predicted.

The prediction of the current W×H block may move on (e.g., by replicating the principle illustrated in the right side of FIG. 18B) to the next set of columns in the current block. The prediction may follow the order of the auto-regression (e.g., from left to right in FIG. 18B).

As used in FIG. 18A, pₒᵤₜ may equal one. This means that a step (e.g., each step) of the AR process in FIG. 18B may predict one block column. As used in FIG. 18A, pₒᵤₜ may take on any value in [symbol] 1, p−1 [symbol] (e.g., 2). As used in FIG. 18A, pᵢₙ may equal p−pₒᵤₜ.

Column-wise AR may be combined with a horizontal block split (e.g., block split horizontally).

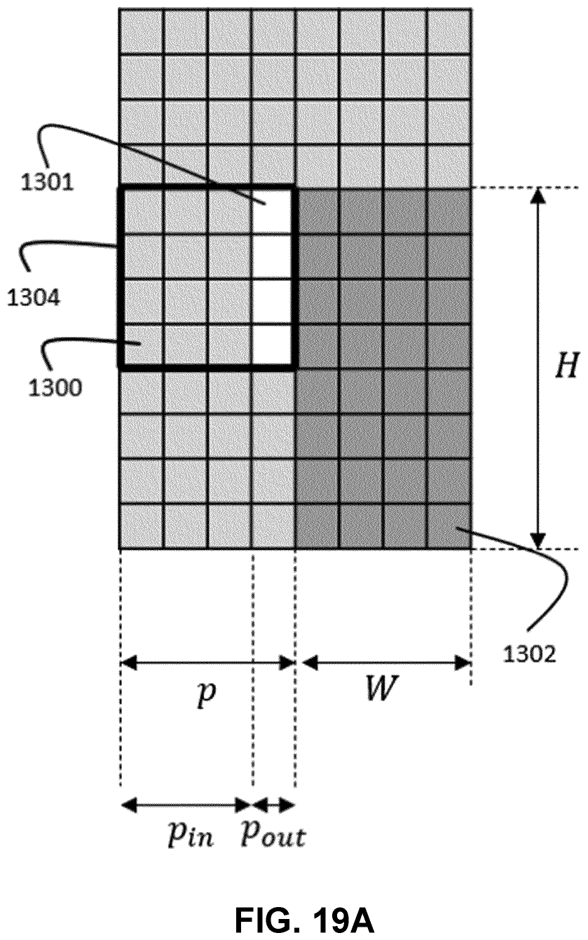

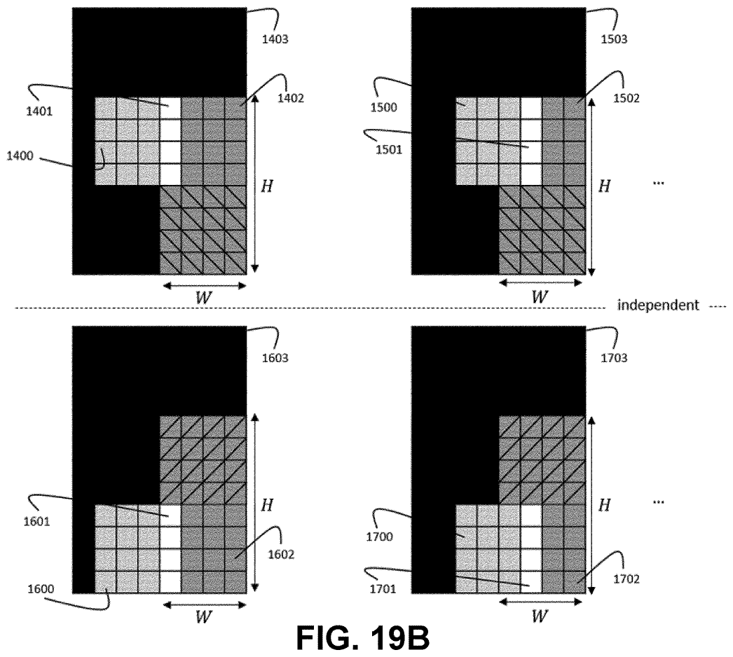

The current block may be split horizontally into several portions. For a portion (e.g., each of the portions), the AR may predict the block portion by sequentially predicting sets of columns. FIGS. 19A and 19B illustrate column-wise AR predicting the current W×H block, where the prediction of each block portion is independent. As illustrated in FIGS. 19A and 19B, W=4, H=8, p=4, pₒᵤₜ=1, and one or more (e.g., two) independent AR processes may be used. FIG. 19A illustrates the learning of the AR model using a neighborhood of decoded pixels around the current W×H block. FIG. 19B illustrates the prediction of the W×H block using the learned AR model. The prediction of a block portion (e.g., each block portion) may be independent of the prediction of another block portion.

As illustrated in FIG. 19A, different examples for learning the AR model may be collected from the neighborhood of decoded pixels of the current W×H block. An example 1304, framed in black, may include the set 1300 of decoded pixels at the input of the AR model and the set 1301 of ground truth pixels. Different examples may be extracted by translating the black frame within a predefined neighborhood of the decoded pixels around the current block. The parameters of the AR model may be learned from the set of collected examples (e.g., as described herein).

As illustrated in the left side of FIG. 19B, the dashed line may delineate the two independent AR processes. Each of the AR processes may apply to a different block portion.

Above the dashed line (e.g., in the first independent AR process), the predicted samples 1401 may be generated by applying the AR model to the input decoded pixels 1400. The decoded pixels 1403 may not be involved in the first independent AR process (e.g., at the current step). The remaining samples 1402 may be predicted by the first independent AR process. A sample (e.g., illustrated with a diagonal line from top-left to bottom-right) may correspond to a sample that is not handled by the first independent AR process.

Below the dashed line (e.g., in the second independent AR process), the predicted samples 1601 may be generated by applying the AR model to the input decoded pixels 1600. The decoded pixels 1603 may not be involved in the second independent AR process (e.g., at the current step). The remaining samples 1602 may be predicted by the second independent AR process. A sample (e.g., illustrated with a diagonal line from top-right to bottom-left) may correspond to a sample that is not handled by the second independent AR process.

As illustrated on the right side of FIG. 19B, the dashed line may delineate the two independent AR processes (e.g., each applying to a different block portion). Above the dashed line (e.g., in the first independent AR process), the predicted samples 1501 may be calculated by applying the AR model to the input 1500. In this case, the input 1500 may include decoded pixels and pixels that were predicted (e.g., at the previous step, for example, as illustrated in the above-left portion of FIG. 19B). The decoded pixels 1503 may not be involved in the first independent AR process (e.g., at the current step). The remaining samples 1502 may be predicted by the first independent AR process.

As illustrated on the right side of FIG. 19B, below the dashed line (e.g., in the second independent AR process), the predicted samples 1701 may be generated by applying the AR model to the input 1700. In this case, the input 1700 may include decoded pixels and pixels that were predicted (e.g., at the previous step, for example, as illustrated in the bottom-left of FIG. 19B). The decoded pixels 1703 may not be involved in the second independent AR process (e.g., at the current step). The remaining samples 1702 may be predicted by the second independent AR process.

The prediction of the current W×H block may move on (e.g., by replicating the principle illustrated on the right side of FIG. 19B) to the next set of columns in the current block. The prediction may follow the order of the AR.

As used in FIG. 19A, pₒᵤₜ may equal one. pₒᵤₜ may take on any value in [symbol] 1, p−1 [symbol] (e.g., 2). As used in FIG. 19A, pᵢₙ may equal p−pₒᵤₜ.

Feature(s) associated with column-wise AR with extended input are provided herein.

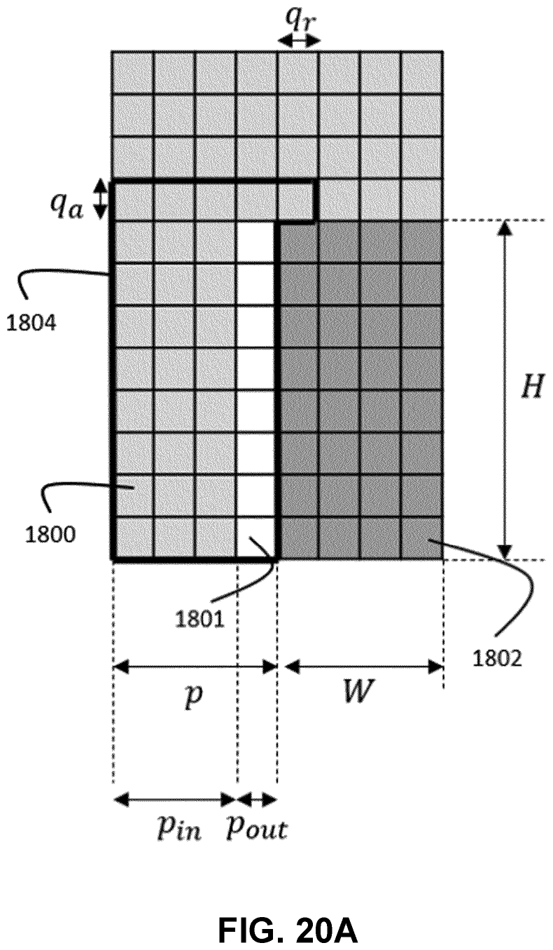

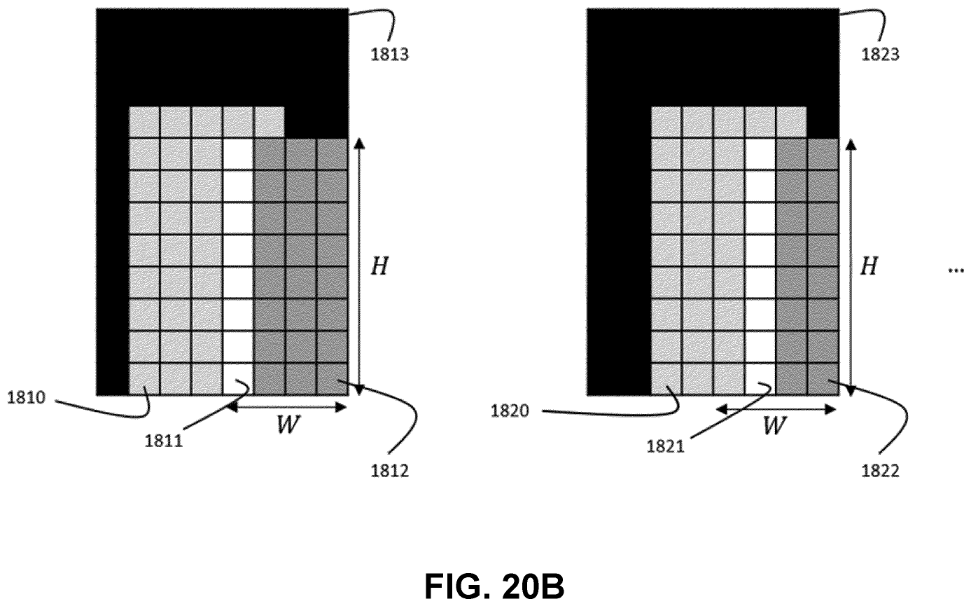

The set of samples fed into the column-wise AR model may be extended towards the top and towards the right. FIGS. 20A and 20B illustrate an example column-wise AR with extended input predicting the current W×H block (e.g., where W=4, H=8, p=4, pₒᵤₜ=1, and qₐ=qᵣ=1). FIGS. 20A and 20B may be similar to FIGS. 18A and 18B, but with the input to the AR model extended by qₐ rows to the top and qᵣ columns to the right (e.g., qₐ=qᵣ=1).

Feature(s) associated with row-wise AR are provided herein.

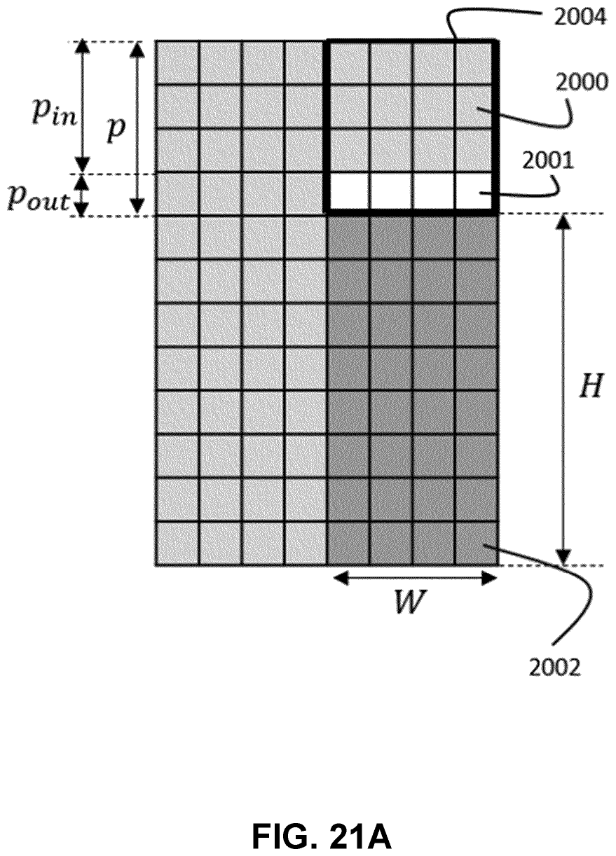

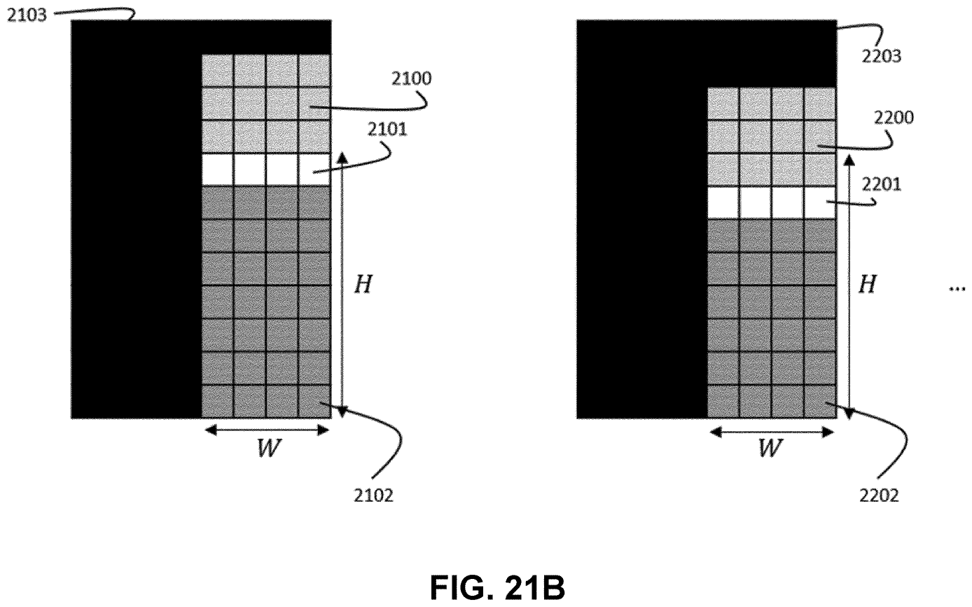

The AR may predict the current block by sequentially predicting sets of rows of the block. FIGS. 21A and 21B illustrate an example row-wise AR predicting the current W×H block (e.g., where W=4, H=8, p=4, and pₒᵤₜ=1). FIGS. 21A and 21B may illustrate a conversion of the column-wise AR in FIGS. 18A and 18B into a row-wise AR.

In FIG. 21A, different examples for learning the AR model may be collected from the neighborhood of decoded pixels of the current W×H block. An example 2004, framed in black, may include the set 2000 of decoded pixels at the input of the AR model and the set 2001 of ground truth pixels. Different examples may be extracted by translating the black frame within a predefined neighborhood of the decoded pixels around the current block. The parameters of the AR model may be learned from the set of collected examples (e.g., based on techniques described herein).

As illustrated on the left side of FIG. 21B, the predicted samples 2101 may be generated by applying the AR model to the input set 2100 of decoded pixels. The decoded pixels 2103 may not be involved in the AR process (e.g., at the current step). The remaining samples 2102 may be predicted.

As illustrated on the right side of FIG. 21B, the predicted samples 2201 may be computed by applying the AR model to the input 2200. The input 2200 may include decoded pixels and pixels that were predicted (e.g., at the previous step). The decoded pixels 2203 may not be involved in the AR process (e.g., at the current step). The remaining samples 2202 may be predicted.

The prediction of the current W×H block may move on (e.g., by replicating the principle illustrated in the right side of FIG. 21B) to the next set of rows in the current block. The prediction may follow the order of the auto-regression (e.g., from top to bottom in FIG. 21B).

As used in FIG. 21A, pₒᵤₜ may equal one. This means that a step (e.g., each step) of the AR process in FIG. 21B may predict one block row. As used in FIG. 21A, pₒᵤₜ may take on any value in [symbol] 1, p−1 [symbol] (e.g., 2). As used in FIG. 21A, pᵢₙ may equal p−pₒᵤₜ.

Row-wise may be combined with a vertical block split (e.g., block split vertically).

The current block may be split vertically into several portions. For a portion (e.g., each portion), the AR may predict the block portion by sequentially predicting sets of rows.

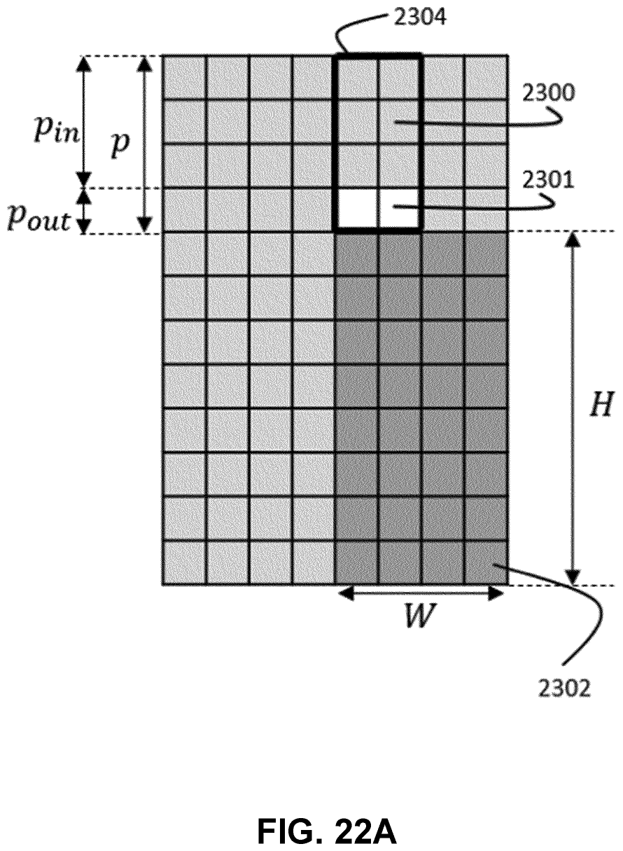

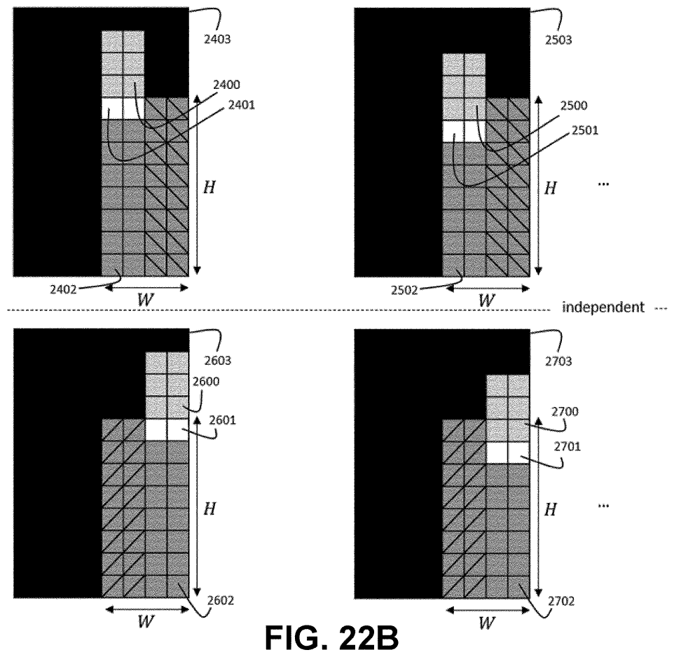

FIGS. 22A and 22B illustrate row-wise AR predicting the current W×H block, where the prediction of each block portion is independent. As illustrated in FIGS. 22A and 22B, W=4, H=8, p=4, pₒᵤₜ=1, and one or more (e.g., two) independent AR processes may be used. FIG. 22A illustrates the learning of the AR model using a neighborhood of decoded pixels around the current W×H block. FIG. 22B illustrates the prediction of the W×H block using the learned AR model. The prediction of a block portion (e.g., each block portion) may be independent of the prediction of another block portion.

As illustrated in FIG. 22A, different examples for learning the AR model may be collected from the neighborhood of decoded pixels of the current W×H block. An example 2304, framed in black, may include the set 2300 of decoded pixels at the input of the AR model and the set 2301 of ground truth pixels. Different examples may be extracted by translating the black frame within a predefined neighborhood of the decoded pixels around the current block. The parameters of the AR model may be learned from the set of collected examples (e.g., as described herein).

As illustrated in the left side of FIG. 22B, the dashed line may delineate the two independent AR processes. Each of the AR processes may apply to a different block portion.

Above the dashed line (e.g., in the first independent AR process), the predicted samples 2401 may be generated by applying the AR model to the input decoded pixels 2400. The decoded pixels 2403 may not be involved in the first independent AR process (e.g., at the current step). The remaining samples 2402 may be predicted by the first independent AR process. A sample (e.g., illustrated with a diagonal line from top-left to bottom-right) may correspond to a sample that is not handled by the first independent AR process.

Below the dashed line (e.g., in the second independent AR process), the predicted samples 2601 may be generated by applying the AR model to the input decoded pixels 2600. The decoded pixels 2603 may not be involved in the second independent AR process (e.g., at the current step). The remaining samples 2602 may be predicted by the second independent AR process. A sample (e.g., illustrated with a diagonal line from top-right to bottom-left) may correspond to a sample that is not handled by the second independent AR process.

As illustrated on the right side of FIG. 22B, the dashed line may delineate the two independent AR processes (e.g., each applying to a different block portion). Above the dashed line (e.g., in the first independent AR process), the predicted samples 2501 may be calculated by applying the AR model to the input 2500. In this case, the input 2500 may include decoded pixels and pixels that were predicted (e.g., at the previous step, for example, as illustrated in the above-left portion of FIG. 22B). The decoded pixels 2503 may not be involved in the first independent AR process (e.g., at the current step). The remaining samples 2502 may be predicted by the first independent AR process.

As illustrated on the right side of FIG. 22B, below the dashed line (e.g., in the second independent AR process), the predicted samples 2701 may be generated by applying the AR model to the input 2700. In this case, the input 2700 may include decoded pixels and pixels that were predicted (e.g., at the previous step, for example, as illustrated in the bottom-left of FIG. 22B). The decoded pixels 2703 may not be involved in the second independent AR process (e.g., at the current step). The remaining samples 2702 may be predicted by the second independent AR process.

The prediction of the current W×H block may move on (e.g., by replicating the principle illustrated on the right side of FIG. 22B) to the next set of rows in the current block. The prediction may follow the order of the AR.

As used in FIG. 22A, pₒᵤₜ may equal one. pₒᵤₜ may take on any value in [symbol] 1, p−1 [symbol] (e.g., 2). As used in FIG. 22A, pᵢₙ may equal p−pₒᵤₜ.

Feature(s) associated with row-wise AR with extended input are provided herein. The set of samples fed into the row-wise AR model may be extended towards the left and towards the bottom. For example, a row-wise AR with extended input predicting a current W×H block may be similar to FIGS. 21A and 21B, but with the input to the AR model extended by qₗ columns to the left and q_{b} rows to the bottom (e.g., qₗ=q_{b}=1).

Feature(s) described herein may be combined into an AR intra prediction mode. For example, feature(s) described herein may be combined into an AR intra prediction mode, the parametrization of the feature(s) being defined by constraints from the SPS/PPS. For example, there may be a constraint on the maximum number of AR steps. The constraint from the SPS/PPS may define a maximum number of AR steps for predicting the current W×H block.

In an example, the AR intra prediction mode may be composed of three sub-modes. The first sub-mode may predict the current sets of columns of pixels from the available “left” samples (e.g., as in FIGS. 18A and 18B). The second sub-mode may predict the current sets of rows of pixels from the available “above” samples (e.g., as in FIGS. 21A and 21B). In the third sub-mode, the current W×H block may be divided into independent sub-blocks (e.g., as in FIG. 16). The AR model with missing samples may learn to cope with the missing samples (e.g., while predicting around the boundaries of each sub-block). If SPS/PPS syntax indicates that at most α>1 AR steps are allowed to predict the current W×H block, the three sub-modes may be parametrized as follows: for the first sub-mode, pₒᵤₜ=max(1, W/α); for the second sub-mode, pₒᵤₜ=max(1, H/α); for the third sub-mode, the number of independent sub-blocks is N=(HW)/α.

For example, if W=4, H=8, and α=4, the first sub-mode may predict one column of pixels per AR step; the second sub-mode may predict two rows of pixels per AR step; and/or in the third sub-mode, the current block may be divided into eight (e.g., distinct) 4×2 sub-blocks.

There may be a constraint on the output of an AR step. For example, the constraint from the SPS/PPS may define a minimum number of pixels to be predicted (e.g., per AR step) during the prediction of the current W×H block.

In an example, the AR intra prediction mode may include the same three sub-modes, as described herein. If SPS/PPS syntax indicates that at least δ∈ [symbol] 1, W [symbol] consecutives columns of pixels are to be predicted per AR step during the prediction of the current W×H block, the three sub-modes may be parametrized as follows: for the first sub-mode, pₒᵤₜ=W/δ; for the second sub-mode, pₒᵤₜ=1; and/or for the third sub-mode, the current W×H block may be divided into W distinct 1×H sub-blocks (e.g., so that a full row of predicted samples is obtained per AR step via W parallel AR processes, each process handling a different sub-block).

For example, if W=4, H=8, and δ=4, the first sub-mode may predict the current W×H block in a (e.g., single) AR step; the second sub-mode may predict one row of pixels per AR step; and/or in the third sub-mode, the current block may be divided into four distinct 1×8 sub-blocks.

A constraint from the SPS/PPS may cancel sub-modes of the AR intra prediction mode. For the current W×H block, if a conflict exists between the rule of the parametrization of a sub-mode of the AR intra prediction mode and the constraint read from the SPS/PPS syntax, the sub-mode may be canceled. In this case, the signaling of the AR intra prediction mode may be adapted.

For example, the first two sub-modes of the AR intra prediction mode may be constrained to predict the current W×H block via at least two (e.g., at least two consecutive) AR steps. The third sub-mode of the AR intra prediction mode may not be split into sub-blocks with a height smaller than 4 and a width smaller than 4. If W=4, H=8, and δ=4, for the first sub-mode, a conflict may exist between the constraint from the SPS/PPS and the (e.g., enforced) at least two consecutive AR steps. For the third sub-mode, a conflict may arise between the constraint from the SPS/PPS and the (e.g., enforced) minimum value of 4 for sub-block height and width. In this case, the first sub-mode and the third sub-mode may be canceled. The AR intra prediction mode may include (e.g., only includes) the second sub-mode. In this case, a flag (e.g., a single flag) may be sufficient to signal the AR intra prediction mode for the current W×H block.

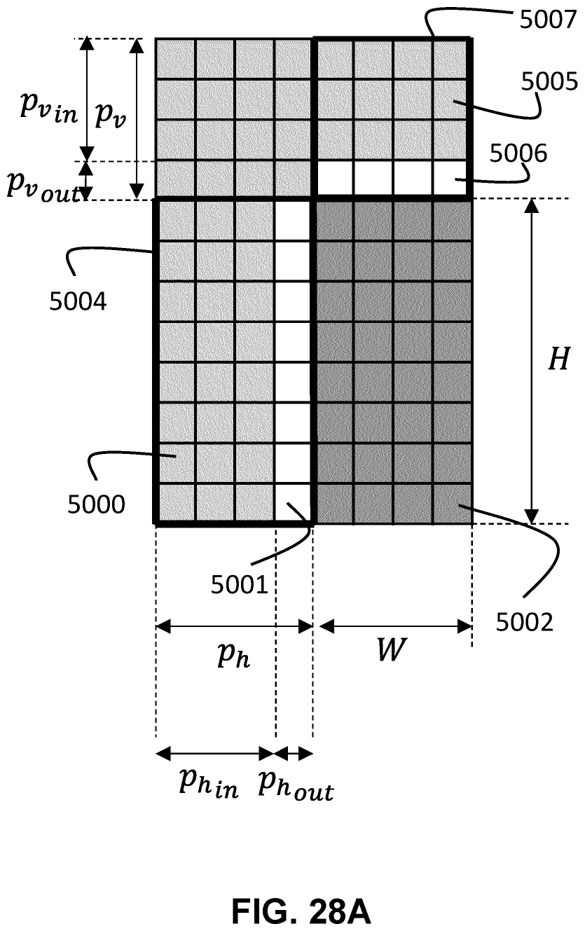

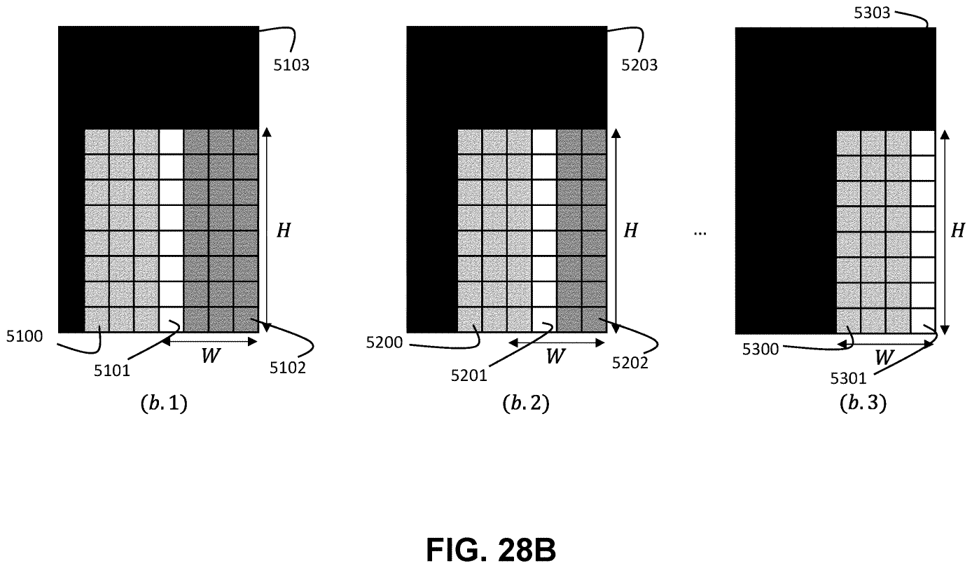

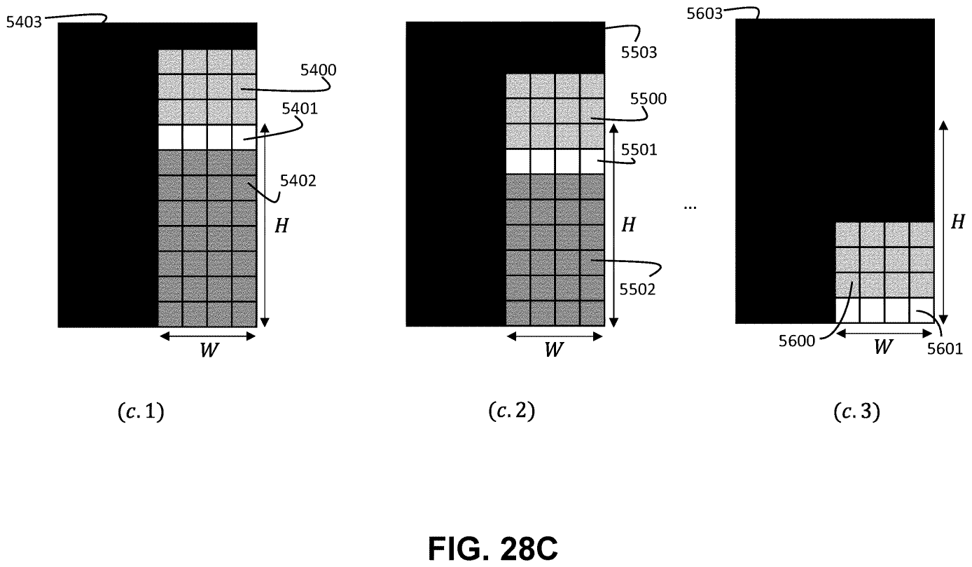

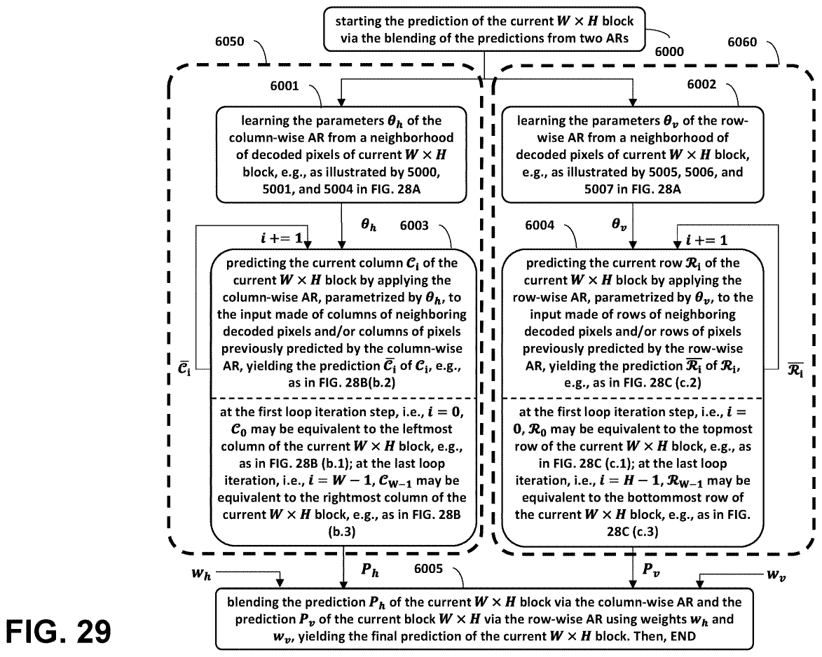

Feature(s) associated with column-wise AR and row-wise AR (e.g., the predictions resulting from the two AR processes, respectively, being then blended) are provided herein. The column-wise AR may predict the current block by sequentially predicting sets of columns of the current block. The row-wise AR may predict the current block by sequentially predicting sets of rows of the current block. The two predictions of the current block (e.g., each arising from a different AR process) may be blended. Blending the two predictions may yield the final prediction of the current block. FIGS. 28A-28C illustrate an example of column-wise AR predicting a current W×H block and row-wise AR predicting the current W×H block, where W=4, H=8, pₕ=4, pᵥ=4, pₕ_{ₒᵤₜ}=1, and pᵥ_{ₒᵤₜ}=1. FIG. 28A illustrates an example of learning an AR model for the column-wise AR using a neighborhood of decoded pixels around the current W×H block. FIG. 28A also illustrates an example of learning an AR model for the row-wise AR using a neighborhood of decoded pixels around the current W×H block. FIG. 28B illustrates the prediction of the current W×H block using the learned AR model associated to the column-wise AR (e.g., from one set of columns of the current block to the next set of columns). FIG. 28C illustrates the prediction of the current W×H block using the learned AR model associated with the row-wise AR (e.g., from one set of rows of the current block to the next set of rows).

In FIG. 28A, different examples for learning the AR model for the column-wise AR may be collected from the neighborhood of decoded pixels around the current W×H block. An example 5004, framed in black, may include the set 5000 of decoded pixels at the input of the AR model for the column-wise AR and the set 5001 of ground truth pixels. Different examples may be extracted by translating the black frame within a predefined neighborhood of the decoded pixels around the current block. The parameters of the AR model for the column-wise AR may be learned from the set of collected examples (e.g., based on techniques described herein). In FIG. 28A, different examples for learning the AR model for the row-wise AR may be collected from the neighborhood of decoded pixels of the current W×H block. An example 5007, framed in black, may include the set 5005 of decoded pixels at the input of the AR model for the row-wise AR and the set 5006 of ground truth pixels. Different examples may be extracted by translating the black frame within a predefined neighborhood of the decoded pixels around the current block. The parameters of the AR model for the row-wise AR may be learned from the set of collected examples (e.g., based on techniques described herein).

The learning of the AR model for the column-wise AR and the learning of the AR model for the row-wise AR may be run in parallel. The learning of the AR model for the column-wise AR and the learning of the AR model for the row-wise AR may be run sequentially.

As illustrated on the left side of FIG. 28B (e.g., denoted by (b.1)), the predicted samples 5101 may be generated (e.g., computed) by applying the AR model associated to the column-wise AR to the input set 5100 of decoded pixels. The decoded pixels 5103 may not be involved in the AR process (e.g., at the current step). The remaining samples 5102 may be predicted (e.g., in a similar manner as the predicted samples 5101, as described herein).

As illustrated at the center of FIG. 28B (e.g., denoted by (b.2)), the predicted samples 5201 may be computed by applying the AR model associated to the column-wise AR to the input set 5200. The input set 5200 may include decoded pixels and pixels that were predicted (e.g., at the previous step depicted at (b.1)). The decoded pixels 5203 may not be involved in the AR process (e.g., at the current step). The remaining samples 5202 may be predicted (e.g., in a similar manner as the predicted samples 5201, as described herein).

The prediction of the current W×H block via the column-wise AR may continue to the next set of columns in the current block (e.g., move on by replicating the principle illustrated at (b.2)). The prediction may follow the order of the auto-regression (e.g., from left to right in FIG. 28B).

As illustrated on the right side of FIG. 28B (e.g., denoted by (b.3), which may be the last step of the column-wise AR), the predicted samples 5301 may be computed by applying the AR model associated to the column-wise AR to the input set 5300. The input set 5300 may include decoded pixels and pixels that were predicted (e.g., at the previous step(s) depicted at (b.1) and/or (b.2)). The decoded pixels 5303 may not be involved in the AR process (e.g., at the current step).

As illustrated on the left side of FIG. 28C (e.g., denoted by (c.1)), the predicted samples 5401 may be generated by applying the AR model associated with the row-wise AR to the input set 5400 of decoded pixels. The decoded pixels 5403 may not be involved in the AR process (e.g., at the current step). The remaining samples 5402 may be predicted (e.g., in a similar manner as the predicted samples 5401, as described herein).

As illustrated at the center of FIG. 28C (e.g., denoted by (c.2)), the predicted samples 5501 may be computed by applying the AR model associated with the row-wise AR to the input set 5500. The input set 5500 may include decoded pixels and pixels that were predicted (e.g., at the previous step depicted at (c.1)). The decoded pixels 5503 may not be involved in the AR process (e.g., at the current step). The remaining samples 5502 may be predicted (e.g., in a similar manner as the predicted samples 5501, as described herein).

The prediction of the current W×H block via the row-wise AR may continue to the next set of rows in the current block (e.g., move on by replicating the principle illustrated at (c.2)). The prediction may follow the order of the auto-regression (e.g., from left to right in FIG. 28C).

As illustrated on the right side of FIG. 28C (e.g., denoted by (c.3), which may be the last step of the row-wise AR), the predicted samples 5601 may be computed by applying the AR model associated with the row-wise AR to the input set 5600. The input set 5600 may include decoded pixels and pixels that were predicted (e.g., at the previous step(s) depicted at (c.1) and/or (c.2)). The decoded pixels 5603 may not be involved in the AR process (e.g., at the current step).

The application of the column-wise AR, as shown in FIG. 28B, and the application of the row-wise AR, as shown in FIG. 28C, may be run in parallel or run sequentially.

The prediction of the current W×H block from the column-wise AR and the prediction of the current W×H block from the row-wise AR may be blended using weights. As an example, if Pₕ(j, i) denotes the prediction of the current W×H block via the column-wise AR at position (j, i), and Pᵥ(j, i) denotes the prediction of the current W×H block via the row-wise AR at position (j, i), the final prediction P(j, i) of the current W×H block at position (j, i) may be P(j, i)=(wₕ(j, i)Pₕ(j, i)+wᵥ(j, i)Pᵥ(j, i)+offset)>>nbShift. wₕ(j, i) and wᵥ(j, i) may be weights at position (j, i). The value of the offset, offset, and number of shifts, nbShift, may depend on the scaling of wₕ(j, i) and wᵥ(j, i). For example, offset may equal 32, and nbShift may equal 6.

As used in FIG. 28A, pₕ_{ₒᵤₜ} may equal one. This means that a step (e.g., each step) of the column-wise AR in FIG. 28B may predict one block column. As used in FIG. 28A, pₕ_{ₒᵤₜ} may take on any value in [symbol] 1, pₕ−1 [symbol] (e.g., 2). As used in FIG. 28A, pₕ_{ᵢₙ} may equal pₕ−pₕ_{ₒᵤₜ}.

As used in FIG. 28A, pᵥ_{ₒᵤₜ} may equal one. This means that a step (e.g., each step) of the row-wise AR in FIG. 28C may predict one block row. As used in FIG. 28A, pᵥ_{ₒᵤₜ} may take on any value in [symbol] 1, pᵥ−1 [symbol] (e.g., 2). As used in FIG. 28A, pᵥ_{ᵢₙ} may equal pᵥ−pᵥ_{ₒᵤₜ}.

In the blending of the predictions from the column-wise AR and row-wise AR, the column-wise AR may be combined with a horizontal block split (e.g., block split horizontally as in FIGS. 19A and 19B).

In the blending of the predictions from the column-wise AR and row-wise AR, the row-wise AR may be combined with a vertical block split (e.g., block split vertically as in FIGS. 22A and 22B).

The blending of multiple predictions (e.g., each coming from a different AR process) may be combined with any of the embodiments described herein (e.g., if the dependencies may be broken by splitting the process into N independent processes in an AR process, as illustrated in FIG. 16).

For a given W×H block, in the process of predicting the W×H block via a column-wise AR, predicting the W×H block via a row-wise AR, and blending the two predictions to yield the final prediction of the W×H block, one or more of the following processes may be run in parallel: learning the AR model associated with the column-wise AR, applying the column-wise AR, learning the AR model associated with the row-wise AR, and/or applying the row-wise AR (e.g. as illustrated in FIG. 29).

In FIG. 29, at 6000, the prediction of the current W×H block via the blending of the two predictions from the two ARs may begin. At 6001, the parameters θₕ of the column-wise AR may be learned from a neighborhood of decoded pixels of the current block. At 6003, for i going from 0 to W−1, the following actions may be performed (e.g., the following inner process may be run): the current column [symbol] of the current W×H block may be predicted by applying the column-wise AR, parametrized by θₕ, to the input made of columns of neighboring decoded pixels and/or columns of pixels previously predicted by the column-wise AR, yielding the prediction [symbol] of [symbol] ;

At 6002, the parameters θᵥ of the row-wise AR may be learned from a neighborhood of decoded pixels of the current block. At 6004, for i going from 0 to H−1, the following actions may be performed (e.g., the following inner process may be run): the current row [symbol] of the current W×H block may be predicted by applying the row-wise AR, parametrized by θᵥ, to the input made of rows of neighboring decoded pixels and/or rows of pixels previously predicted by the row-wise AR, yielding the prediction [symbol] of [symbol] .

At 6005, the prediction Pₕ of the current W×H block (e.g., via the column-wise AR) and the prediction Pᵥ of the current W×H block (e.g., via the row-wise AR) may be blended using weights, yielding the final prediction of the current W×H block. The process may (e.g., then) end. In FIG. 29, one or more of the actions described in dashed boxes 6050 and 6060 may be run in parallel. There may be no synchronization constraint between 6050 and 6060 during the parallel runs. For example, the actions described in 6003 may start even though the action described at 6002 is not completed yet. As another example, the actions described in 6004 may start even though the action described at 6001 is not completed yet.

An AR model may be precomputed to break dependencies. For example, a number of models may be deduced from the original model to break the dependencies from a sample (e.g., one sample) to the next sample.

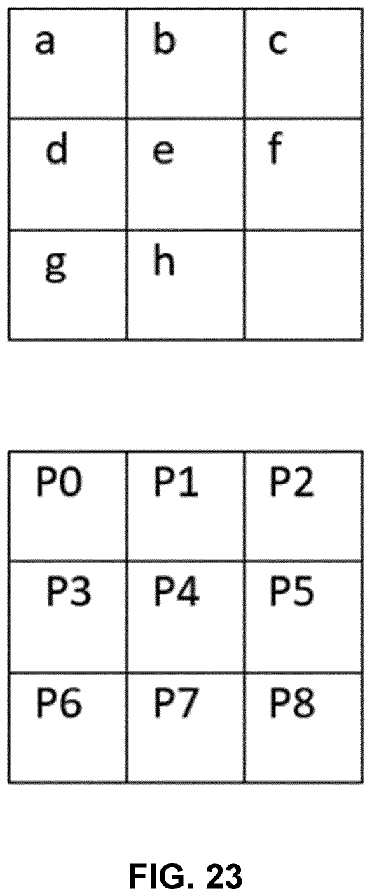

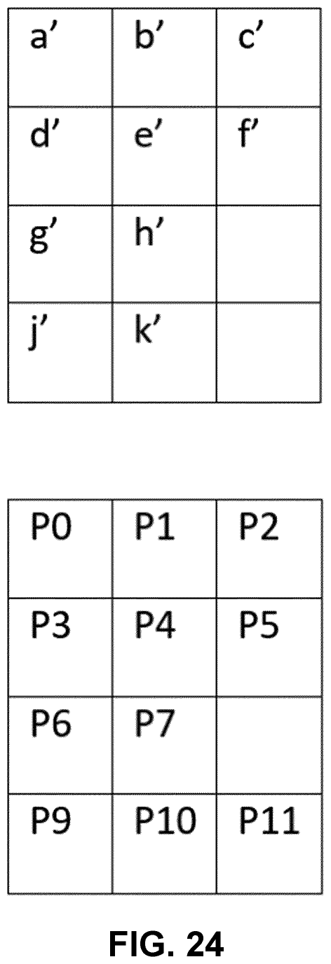

For example, for a 3×3 model as illustrated in FIG. 23 (e.g., where the letter a-h represents the coefficients applied to each sample P0 to P7), the sample P8 may be reconstructed using the model (e.g., based on the equation P8=(a*P0+b*P1+c*P2+d*P3+e*P4+f*P5+g*P6+h*P7)>>M). A model, such as the one illustrated in FIG. 24, may be deduced to be run in parallel (e.g., where a′=(a*f)>>N; b′=(b*f)>>N; c′=(c*f)>>N; d′=(a*f+d)>>N; e′=(b+f*e)>>N; f′=(c+f*f)>>N; j′=g>>P; and j′=h>>P). N may be computed to adjust the bit depth of the resulting coefficients. For example, N may be selected to be the original bit depth of the coefficient. P may be 0 (e.g., no adaptation for g and h).

A rounding offset (e.g., 1<<(N−1)) may be added to the factor (e.g., before right shifting).

The model may use an (e.g., one) additional line. The model may use a computed coefficient from the original model. The computed model may be able to process one or more (e.g., two) lines at the same time, with only a small difference compared to the original model (e.g., due to the coefficients approximation). For example, N lines may be processed together.

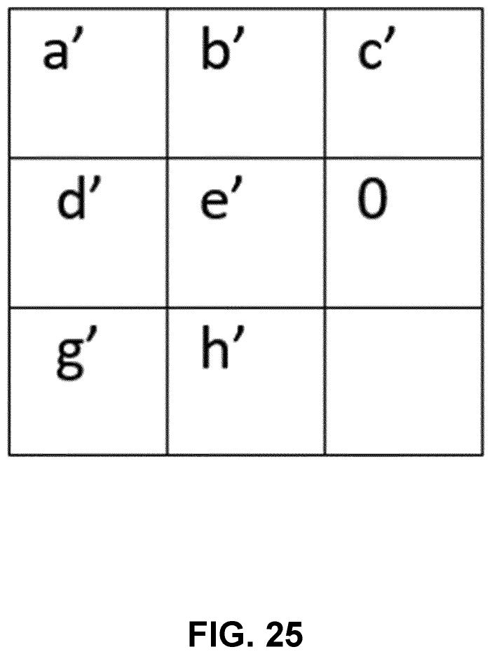

An AR model with missing samples may be learned. To increase the parallelism, several models may be learned (e.g., based on the template). For example, to allow two consecutive lines to be processed in parallel, the default model may be learned, and another (e.g., additional) model may be learned. The coefficient associated with the sample above the current sample may not be used in the model (e.g., as illustrated in FIG. 25). In this case, the sample P8 may be reconstructed using the model (e.g., based on the equation: P8=(a′*P0+b′*P1+c′*P2+d′*P3+e′*P4+g′*P6+h′*P7)>>M).

The default model may be used for a (e.g., one) first line. The adapted model may be used (e.g., in parallel) for the line below (e.g., just below) the first line.

One or more (e.g., several) models may be learned. The models may have more missing samples (e.g., compared to other models). The missing samples may be samples on the left.

Feature(s) associated with a subsampled block are provided herein. For a block larger than N, the block reconstruction may be performed on a subsampled block.

The model may be computed using samples every N pixels (e.g., N=2), and applied every N pixels.

The area size used to compute/apply the model may be N×N times bigger (e.g., than the model). The number of samples used to compute/apply the model may stay the same. A (e.g., simple) filtering may be applied to the missing samples (e.g., after the samples have been computed) to reconstruct the samples from the computed samples. A linear interpolation may be computed for the missing samples. The missing samples may be computed using a simple average of the four neighbors (e.g., top, left, bottom, right).

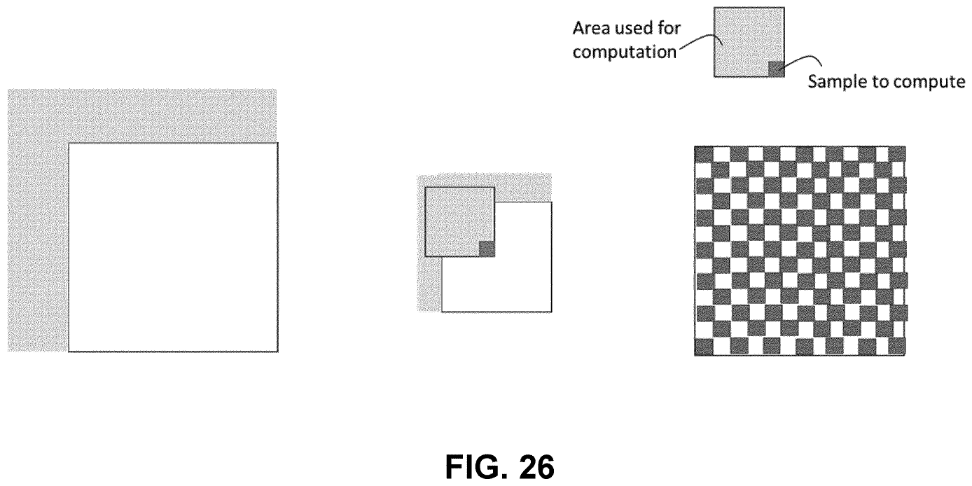

FIG. 26 illustrates an example of down-sampling reconstruction.

In examples, template samples (e.g., only the template samples) may be used.

Feature(s) associated with position-dependent EIP prediction are provided herein. A dependency (e.g., every dependency) between samples within the current block to predict may be removed.

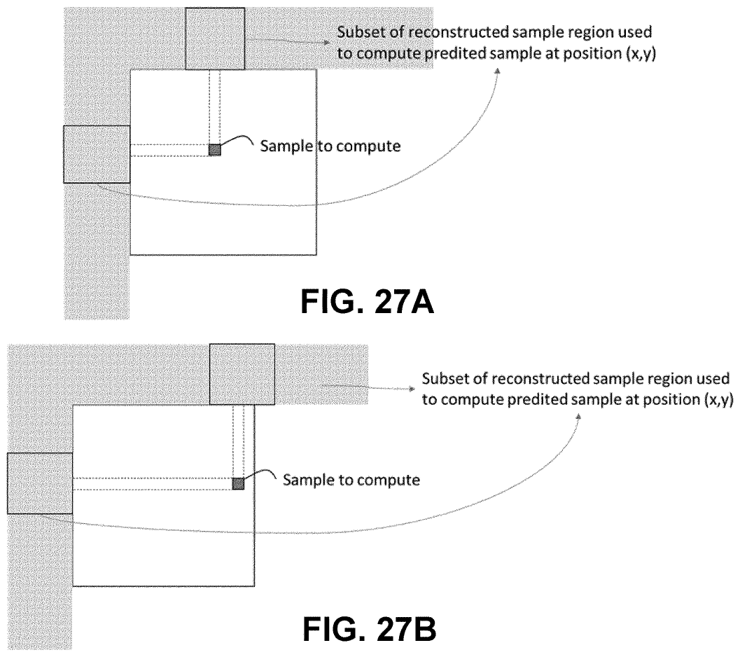

The prediction of a sample at a given (x, y) position in current block may be predicted as the filtering operation of two or more (e.g., two) sub-regions (e.g., subsets) of neighboring samples from the overall region of reconstructed samples. The subsets (e.g., two subsets) may be selected based on the position (x, y) of the considered sample to predict, respectively, in the above and in the left part of reconstructed samples region considered. FIG. 27 illustrates examples of position-dependent EIP-based prediction of a sample in a current block (e.g., depending only on reconstructed samples). If the above-only or the left-only region of the reconstructed area (e.g., illustrated in the middle and right examples of FIG. 12, respectively) is selected for the current block, a (e.g., only one) sub-region of samples may be chosen according to the x- or y-position of the sample to predict. The input samples to the EIP extrapolation filter may be samples taken from (e.g., only from) reconstructed samples out of the current block (e.g., not from samples inside the current block).

One or more (e.g., two) sets of input samples may be taken from the above subset and left subset of reconstructed samples. The sets of input samples may be given to the EIP filter (e.g., to the EIP filtering process). One or more (e.g., two) filtered samples may be obtained from one or more (e.g., two separate) EIP steps (e.g., respectively from the above subset and left subset of reconstructed samples). The filtered samples may be averaged to produce a predicted sample (e.g., the final predicted sample).

The average may be weighted according to the position of the predicted samples, as follows:

$${Pred}_{final} ( x , y ) = \frac{{w}_{x} \times {EIP}_{left} ( y ) + {w}_{y} \times {EIP}_{above} ( x , y )}{{w}_{x} + {w}_{y}}$$

where weights wₓ and w_{y} decrease according to distance x and y to the left and above borders of the block, respectively.

If a (e.g., a single) above or left reconstructed area (e.g., as illustrated in the middle and right examples of FIG. 12, respectively) is used for current block, a (e.g., a single) EIP process may be used to predict a sample (e.g., each sample) of the current block. For example, if the (e.g., single) left reconstructed region is considered, the prediction may be represented by the following form:

$${Pred}_{final} ( x , y ) = {EIP}_{left} ( y )$$

Position-dependent blending (e.g., with some other intra predictor) may be used, in which case the prediction may be represented by the following configuration:

$${Pred}_{final} ( x , y ) = \frac{{w}_{x} \times {EIP}_{left} ( y ) + {w}_{y} \times {Pred}_{intra} ( x , y )}{{w}_{x} + {w}_{y}}$$

where Predᵢₙₜᵣₐ(x, y) represents a usual, non-EIP, intra prediction of a sample at position (x, y). In the case of the (e.g., single) left-only reconstructed (e.g., illustrated on the right side of FIG. 12), Predᵢₙₜᵣₐ(x, y) may be the vertical prediction of sample (x, y) from above intra reference samples.

The EIP filter parameters may be optimized. For example, the EIP parameters may be optimized based on the EIP being used to predict samples spatially distant from the reconstructed samples used as inputs to the EIP process.

Feature(s) associated with weighted averaging with smooth intra prediction are provided herein.

The position-dependent EIP prediction may be fused (e.g., combined) with another intra prediction of a sample (e.g., each sample) in the blocks. For example, weighted averaging of EIP prediction with the planar mode may be performed. This may account for the fact that EIP prediction based on samples (e.g., only on samples) outside the block may be less accurate for samples that are far from the reconstructed region.

In this case, the prediction may be represented using the following form:

$${Pred}_{final} ( x , y ) = W ( x , y ) \times EI ( x , y ) + ( 1 - W ( x , y ) ) \times {Pred}_{intra} ( x , y )$$

where W is a two-dimensional (2D) set of weights, the values of which decrease according to the distance of (x, y) to the left and top border of the considered block.

The intra prediction Predᵢₙₜᵣₐ(x, y) of previous equation may correspond to planar intra prediction and/or matrix-based intra prediction (MIP).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A device for video decoding, the device comprising:
a processor configured to:
obtain determine a first auto-regressive prediction model for a first block;
obtain a first set of reference samples associated with the first block;
determine, in parallel, a first prediction sample and a second prediction sample of the first block based on the first set of reference samples using the first auto-regressive prediction model;
decode the first block based on the first prediction sample and the second prediction sample;
determine a second auto-regressive prediction model for a second block, wherein the second auto-regressive prediction model has different parameters than the first auto-regressive prediction model;
obtain a second set of reference samples associated with the second block;
determine, in parallel, a third prediction sample and a fourth prediction sample of the second block based on the second set of reference samples using the second auto-regressive prediction model; and
decode the second block based on the third prediction sample and the fourth prediction sample.

2. The device of claim 1, wherein the first set of reference samples comprises a plurality of predicted samples in the first block, and the first prediction sample and the second prediction sample are located on successive lines of the first block.

3. The device of claim 1, wherein the first set of reference samples comprises a plurality of reconstructed samples that neighbor the first block.

4. The device of claim 1, wherein the processor being configured to obtain the first auto-regressive prediction model for the first block comprises the processor being configured to determine a parameter of the first auto-regressive prediction model, based on a first subset of the first set of reference samples and a second subset of the first set of reference samples; and the processor being configured to determine, in parallel, the first prediction sample and the second prediction sample of the first block based on the first set of reference samples and the first auto-regressive prediction model comprises the processor being configured to generate the first prediction sample and the second prediction sample, as outputs of the first auto-regressive prediction model, based on the parameter and the second subset of the first set of reference samples being used as an input to the first auto-regressive prediction model.

5. The device of claim 1, wherein the first set of reference samples comprises a first column of pixels and a second column of pixels, and the processor being configured to determine, in parallel, the first prediction sample and the second prediction sample of the first block based on the first set of reference samples and the first auto-regressive prediction model comprises the processor being configured to:
generate a third column of pixels, as a first output of the first auto-regressive prediction model, based on the first column of pixels and the second column of pixels being used as a first set of inputs to the first auto-regressive prediction model, wherein the third column of pixels comprises the first prediction sample and the second prediction sample.

6. The device of claim 5, wherein the processor is further configured to:
generate a fourth column of pixels, as a second output of the first auto-regressive prediction model, based on the second column of pixels and the third column of pixels being used as a second set of inputs to the first auto-regressive prediction model, wherein the fourth column of pixels comprises a fifth prediction sample and a sixth prediction sample.

7. The device of claim 1, wherein the first set of reference samples comprises a first row of pixels and a second row of pixels, and the processor being configured to determine, in parallel, the first prediction sample and the second prediction sample of the first block based on the first set of reference samples and the first auto-regressive prediction model comprises the processor being configured to:
generate a third row of pixels, as a first output of the first auto-regressive prediction model, based on the first row of pixels and the second row of pixels being used as a first set of inputs to the first auto-regressive prediction model, wherein the third row of pixels comprises the first prediction sample and the second prediction sample.

8. The device of claim 7, wherein the processor is further configured to:
generate a fourth row of pixels, as a second output of the first auto-regressive prediction model, based on the second row of pixels and the third row of pixels being used as a second set of inputs to the first auto-regressive prediction model, wherein the fourth row of pixels comprises a fifth prediction sample and a sixth prediction sample.

9-15. (canceled)

16. A device for video decoding, the device comprising:
a processor configured to:
obtain determine a first auto-regressive prediction model for a first block;
obtain a first set of reference samples associated with the first block;
determine, in parallel, a first prediction sample and a second prediction sample of the first block based on the first set of reference samples using the first auto-regressive prediction model;
decode the first block based on the first prediction sample and the second prediction sample;
determine a second auto-regressive prediction model for a second block, wherein the second auto-regressive prediction model has different parameters than the first auto-regressive prediction model;
obtain a second set of reference samples associated with the second block;
determine, in parallel, a third prediction sample and a fourth prediction sample of the second block based on the second set of reference samples using the second auto-regressive prediction model; and
decode the second block based on the third prediction sample and the fourth prediction sample.

17. The device of claim 16, wherein the first set of reference samples comprises a plurality of predicted samples in the first block, and the first prediction sample and the second prediction sample are located on successive lines of the first block.

18. The device of claim 16, wherein the first set of reference samples comprises a plurality of reconstructed samples that neighbor the first block.

19. The device of claim 16, wherein the processor being configured to obtain the first auto-regressive prediction model for the first block comprises the processor being configured to determine a parameter of the first auto-regressive prediction model, based on a first subset of the first set of reference samples and a second subset of the first set of reference samples; and the processor being configured to determine, in parallel, the first prediction sample and the second prediction sample of the first block based on the first set of reference samples and the first auto-regressive prediction model comprises the processor being configured to generate the first prediction sample and the second prediction sample, as outputs of the first auto-regressive prediction model, based on the parameter and the second subset of the first set of reference samples being used as an input to the first auto-regressive prediction model.

20. The device of claim 16, wherein the first set of reference samples comprises a first column of pixels and a second column of pixels, and the processor being configured to determine, in parallel, the first prediction sample and the second prediction sample of the first block based on the first set of reference samples and the first auto-regressive prediction model comprises the processor being configured to:
generate a third column of pixels, as a first output of the first auto-regressive prediction model, based on the first column of pixels and the second column of pixels being used as a first set of inputs to the first auto-regressive prediction model, wherein the third column of pixels comprises the first prediction sample and the second prediction sample.

21. The device of claim 20, wherein the processor is further configured to:
generate a fourth column of pixels, as a second output of the first auto-regressive prediction model, based on the second column of pixels and the third column of pixels being used as a second set of inputs to the first auto-regressive prediction model, wherein the fourth column of pixels comprises a fifth prediction sample and a sixth prediction sample.

22. The device of claim 16, wherein the first set of reference samples comprises a first row of pixels and a second row of pixels, and the processor being configured to determine, in parallel, the first prediction sample and the second prediction sample of the first block based on the first set of reference samples and the first auto-regressive prediction model comprises the processor being configured to:
generate a third row of pixels, as a first output of the first auto-regressive prediction model, based on the first row of pixels and the second row of pixels being used as a first set of inputs to the first auto-regressive prediction model, wherein the third row of pixels comprises the first prediction sample and the second prediction sample.

23. The device of claim 22, wherein the processor is further configured to:
generate a fourth row of pixels, as a second output of the first auto-regressive prediction model, based on the second row of pixels and the third row of pixels being used as a second set of inputs to the first auto-regressive prediction model, wherein the fourth row of pixels comprises a fifth prediction sample and a sixth prediction sample.

24. A device for video encoding, the device comprising:
a processor configured to:
obtain determine a first auto-regressive prediction model for a first block;
obtain a first set of reference samples associated with the first block;
determine, in parallel, a first prediction sample and a second prediction sample of the first block based on the first set of reference samples using the first auto-regressive prediction model;
encode the first block based on the first prediction sample and the second prediction sample;
determine a second auto-regressive prediction model for a second block, wherein the second auto-regressive prediction model has different parameters than the first auto-regressive prediction model;
obtain a second set of reference samples associated with the second block;
determine, in parallel, a third prediction sample and a fourth prediction sample of the second block based on the second set of reference samples using the second auto-regressive prediction model; and
encode the second block based on the third prediction sample and the fourth prediction sample.

25. The device of claim 24, wherein the first set of reference samples comprises a plurality of predicted samples in the first block, and the first prediction sample and the second prediction sample are located on successive lines of the first block.

26. The device of claim 24, wherein the first set of reference samples comprises a plurality of reconstructed samples that neighbor the first block.

27. The device of claim 24, wherein the processor being configured to obtain the first auto-regressive prediction model for the first block comprises the processor being configured to determine a parameter of the first auto-regressive prediction model, based on a first subset of the first set of reference samples and a second subset of the first set of reference samples; and the processor being configured to determine, in parallel, the first prediction sample and the second prediction sample of the first block based on the first set of reference samples and the first auto-regressive prediction model comprises the processor being configured to generate the first prediction sample and the second prediction sample, as outputs of the first auto-regressive prediction model, based on the parameter and the second subset of the first set of reference samples being used as an input to the first auto-regressive prediction model.
